(19) United States
(12) Patent Application Publication
(10) Pub. No.: US 2026/0299261 A1
(43) Pub. Date: Oct. 1, 2026

(54) WIDE-ANGLE LENS

(71) Applicants: NIDEC INSTRUMENTS (GUANGDONG) CORPORATION, Guangdong Province (CN); NIDEC INSTRUMENTS CORPORATION, Nagano (JP)

(72) Inventors: Liang JINHUI, Guangdong Province (CN); Takuya KASAHARA, Nagano (JP)

(21) Appl. No.: 19/632,418

(22) Filed: Mar. 30, 2026

(30) Foreign Application Priority Data
Mar. 31, 2025 (CN) 202510399794.1

(51) Int. Cl. G02B 13/00; G02B 1/04; G02B 7/02; G02B 9/62

(52) U.S. Cl. CPC G02B 13/0045; G02B 1/041; G02B 7/025; G02B 7/028; G02B 9/62; G02B 13/006

(57) ABSTRACT

A wide-angle lens includes a front lens set, an aperture, and a rear lens set in sequence from an object side to an image side. The front lens set includes first to third lenses in sequence from the object side to the image side. The rear lens set includes fourth to sixth lenses in sequence from the object side to the image side. Each of the first and second lenses is a negative lens with a concave lens surface facing the image side, the third lens is a positive lens with a convex lens surface facing the image side, the fourth lens is a glass biconvex lens, the fifth lens is a lens with a concave lens surface facing the image side, the sixth lens is a biconvex lens. The total object-image distance of the lens system is do, the focal length of the fourth lens is f4, and 3.000<d0/f4<4.000.

### RELATED APPLICATIONS

The present invention claims priority under 35 U.S.C. § 119 to Chinese Application No. 202510399794.1 filed Mar. 31, 2025, the entire content of which is incorporated herein by reference

### BACKGROUND

### Field of the Invention

The present invention relates to a wide-angle lens.

### Description of the Related Documents

Lenses used in vehicles, surveillance cameras, etc. are required to have a wide angle, high resolution, and stable temperature characteristics.

When plastic lenses are used to form wide-angle lenses, it is difficult to obtain sufficient temperature characteristics. Stable temperature characteristics include, for example, suppressing the shift of a focus position relative to a shooting element due to changes in ambient temperature.

Patent Document 1 describes a wide-angle lens in which, among a third lens and a fourth lens arranged on both sides of an aperture, the fourth lens is configured as a glass lens with small refractive index variation due to temperature changes, and the fourth lens is used to eliminate the shift of the focus position with changes in ambient temperature.

### DOCUMENT IN RELATED ART

### Patent Document

Patent Document 1: Japanese Patent No. 7512276

### SUMMARY

### Technical Problem to be Solved by the Invention

However, in the case of the wide-angle lens in Patent Document 1, although its design aims to eliminate the shift of the focus position in a wide-angle unit, for example, when the lens unit with the wide-angle lens and a lens barrel that holds the wide-angle lens is configured in a camera, and a holding component of the camera that holds the lens unit is made of resin, because the temperature characteristics of the holding component is not considered, the shift of the focus position may still occur during thermal expansion of the holding component due to excessive elimination on the shift of the focus position by the fourth lens as a glass lens. Therefore, there is still room for further improvement on the temperature characteristics of wide-angle lenses.

### Technical Solution Adopted to Solve the Technical Problem

In view of the above problems, one of the objectives of the present invention is to provide a wide-angle lens, which can appropriately eliminate the shift of a focus position with changes in ambient temperature, and can suppress excessive elimination on the shift of the focus position by a fourth lens as a glass lens.

In order to achieve the above objective, the present invention provides a wide-angle lens, including a front lens set, an aperture, and a rear lens set in sequence from an object side to an image side, where the front lens set is composed of a first lens, a second lens, and a third lens arranged in sequence from the object side to the image side; the rear lens set is composed of a fourth lens, a fifth lens, and a sixth lens arranged in sequence from the object side to the image side; the first lens is a negative lens with a concave lens surface facing the image side, the second lens is a negative lens with a concave lens surface facing the image side, the third lens is a positive lens with a convex lens surface facing the image side, the fourth lens is a glass biconvex lens, the fifth lens is a lens with a concave lens surface facing the image side, and the sixth lens is a biconvex lens; when the total object-image distance of the lens system is denoted as do, and the focal length of the fourth lens is denoted as f4, the following conditional expression is satisfied: 3.000<d0/f4<4.000.

In the present invention, because the ratio of the total object-image distance do of the lens system to the focal length f4 of the fourth lens (d0/f4) is more than the lower limit (3.000), the shift of a focus position with changes in ambient temperature can be appropriately eliminated based on the fourth lens. In addition, because the ratio (d0/f4) is less than the upper limit (4.000), excessive elimination on the shift of the focus position with changes in ambient temperature based on the fourth lens can be prevented. Moreover, the wide-angle lens of the present invention considers temperature correction of a holding component on a camera side to which the wide-angle lens is applied, even if the holding component thermally expands, excessive elimination on the shift of the focus position by the fourth lens as a glass lens can be suppressed.

Preferably, 3.331<d0/f4<3.586.

In the wide-angle lens of the present invention, preferably, when the total focal length of the lens system is denoted as f0, the following conditional expression is satisfied: 3.500<f4/f0<5.500. In this embodiment, because the ratio of the focal length f4 of the fourth lens to the total focal length f0 of the lens system (f4/f0) is more than the lower limit (3.500), the shift of the focus position with changes in ambient temperature can be appropriately eliminated based on the fourth lens. In addition, because the ratio (f4/f0) is less than the upper limit (5.500), excessive elimination on the shift of the focus position with changes in ambient temperature based on the fourth lens can be prevented.

More preferably, 4.000<f4/f0<5.000.

In the wide-angle lens of the present invention, preferably, when the total focal length of the lens system is denoted as f0 and the curvature radius of the image-side lens surface of the fourth lens is denoted as R42, the following conditional expression is satisfied: −7.500<R42/f0<−3.500. In this embodiment, because the ratio of the curvature radius R42 of the image-side lens surface of the fourth lens to the total focal length f0 of the lens system (R42/f0) is more than the lower limit (−7.500), various aberrations can be appropriately corrected. In addition, because the upper limit (−3.500) is set for the ratio (R42/f0), the curvature radius R42 of the image-side lens surface of the fourth lens can be suppressed from being too small. Therefore, the image-side lens surface of the fourth lens can be easily formed.

In the wide-angle lens of the present invention, preferably, when the total focal length of the lens system is denoted as f0 and the center thickness of the third lens is denoted as T3, the following conditional expression is satisfied: 2.000<T3/f0<4.000. In this embodiment, because the ratio of the center thickness T3 of the third lens to the total focal length f0 of the lens system (T3/f0) is more than the lower limit (2.000), the balance between the chromatic aberrations of magnification generated by the first lens and the second lens and the chromatic aberration of magnification of the third lens that corrects the previous chromatic aberrations of magnification can be rationalized, and spherical aberration and coma aberration can be corrected. In addition, because the ratio (T3/f0) is less than the upper limit, the center thickness T3 of the third lens will not be unnecessarily too thick. Therefore, the total object-image distance of the lens can be shortened.

In the wide-angle lens of the present invention, preferably, when the effective radius of the object-side lens surface of the first lens is denoted as sd11, the following conditional expression is satisfied: 2.000<d0/sd11<3.000. In this embodiment, because the ratio of the total object-image distance do of the lens system to the effective radius sd11 of the object-side lens surface of the first lens (d0/sd11) is more than the lower limit (2.000), an increase in the diameter of the first lens can be avoided. Therefore, miniaturization of the wide-angle lens (in the radial direction) can be achieved. In addition, because the ratio (d0/sd11) is less than the upper limit (3.000), an increase in the total length of the lens system can be avoided. Therefore, miniaturization of the wide-angle lens (in the optical axis direction) can be achieved. Alternatively, the diameter of the first lens will not be too small. Therefore, peripheral illumination can be ensured (darkening can be avoided).

In the wide-angle lens of the present invention, preferably, when the maximum height of image is denoted as HOI, the following conditional expression is satisfied: 5.000<d0/HOI<10.000. In this embodiment, because the ratio of the total object-image distance do of the lens system to the maximum height of image HOI (do/HOI) is more than the lower limit (5.000), various aberrations can be effectively corrected. In addition, because the ratio (d0/HOI) is less than the upper limit (10.000), an increase in the total length of the lens can be avoided. Therefore, miniaturization of the wide-angle lens (in the optical axis direction) can be achieved.

In the wide-angle lens of the present invention, preferably, when the full field of angle of the wide-angle lens is denoted as w, the following conditional expression is satisfied: 180°<<<210°. In this embodiment, because the full field of angle ω of the wide-angle lens is more than the lower limit (180°), a wide angle can be achieved. In addition, because ω is less than the upper limit (210°), the peripheral illumination can be prevented from falling off compared to the center, and the periphery of an image can be prevented from darkening.

In the wide-angle lens of the present invention, preferably, when the total focal length of the lens system is denoted as f0, the following conditional expression is satisfied: 13.000<d0/f0<18.000. In this embodiment, because the ratio of the total object-image distance do of the lens system to the total focal length f0 of the lens system (d0/f0) is more than the lower limit (13.000), spherical aberration and distortion aberration can be appropriately corrected. In addition, because the ratio (d0/f0) is less than the upper limit (18.000), an excessive increase in lens diameter can be suppressed, and an increase in the total length of the lens system can be avoided.

### BRIEF DESCRIPTION OF THE DRAWINGS

FIG. 1 is an explanatory diagram of a wide-angle lens according to Embodiment 1 of the present invention.

FIG. 2 is an explanatory diagram illustrating the astigmatism and distortion of the wide-angle lens shown in FIG. 1.

FIG. 3 is an explanatory diagram illustrating the chromatic aberration of magnification of the wide-angle lens shown in FIG. 1.

FIG. 4 is an explanatory diagram illustrating the spherical aberration of the wide-angle lens shown in FIG. 1.

FIGS. 5A to 5J are explanatory diagrams illustrating lateral aberrations of the wide-angle lens shown in FIG. 1.

FIG. 6 is an explanatory diagram of a wide-angle lens according to Embodiment 2 of the present invention.

FIG. 7 is an explanatory diagram illustrating the astigmatism and distortion of the wide-angle lens shown in FIG. 6.

FIG. 8 is an explanatory diagram illustrating the chromatic aberration of magnification of the wide-angle lens shown in FIG. 6.

FIG. 9 is an explanatory diagram illustrating the spherical aberration of the wide-angle lens shown in FIG. 6.

FIGS. 10A to 10J are explanatory diagrams illustrating lateral aberrations of the wide-angle lens shown in FIG. 6.

FIG. 11 is an explanatory diagram of a wide-angle lens according to Embodiment 3 of the present invention.

FIG. 12 is an explanatory diagram illustrating the astigmatism and distortion of the wide-angle lens shown in FIG. 11.

FIG. 13 is an explanatory diagram illustrating the chromatic aberration of magnification of the wide-angle lens shown in FIG. 11.

FIG. 14 is an explanatory diagram illustrating the spherical aberration of the wide-angle lens shown in FIG. 11.

FIGS. 15A to 15J explanatory diagrams illustrating lateral aberrations of the wide-angle lens shown in FIG. 11.

FIG. 16 is an explanatory diagram of a wide-angle lens according to Embodiment 4 of the present invention.

FIG. 17 is an explanatory diagram illustrating the astigmatism and distortion of the wide-angle lens shown in FIG. 16.

FIG. 18 is an explanatory diagram illustrating the chromatic aberration of magnification of the wide-angle lens shown in FIG. 16.

FIG. 19 is an explanatory diagram illustrating the spherical aberration of the wide-angle lens shown in FIG. 16.

FIGS. 20A to 20J are explanatory diagrams illustrating lateral aberrations of the wide-angle lens shown in FIG. 16.

FIG. 21 is an explanatory diagram of a wide-angle lens according to Embodiment 5 of the present invention.

FIG. 22 is an explanatory diagram illustrating the astigmatism and distortion of the wide-angle lens shown in FIG. 21.

FIG. 23 is an explanatory diagram illustrating the chromatic aberration of magnification of the wide-angle lens shown in FIG. 21.

FIG. 24 is an explanatory diagram illustrating the spherical aberration of the wide-angle lens shown in FIG. 21.

FIGS. 25A to 25J are explanatory diagrams illustrating lateral aberrations of the wide-angle lens shown in FIG. 21.

FIG. 26 is an explanatory diagram of a wide-angle lens according to Embodiment 6 of the present invention.

FIG. 27 is an explanatory diagram illustrating the astigmatism and distortion of the wide-angle lens shown in FIG. 26.

FIG. 28 is an explanatory diagram illustrating the chromatic aberration of magnification of the wide-angle lens shown in FIG. 26.

FIG. 29 is an explanatory diagram illustrating the spherical aberration of the wide-angle lens shown in FIG. 26.

FIGS. 30A to 30J are explanatory diagrams illustrating lateral aberrations of the wide-angle lens shown in FIG. 26.

### DETAILED DESCRIPTION

A wide-angle lens 100 of the present invention will be explained in Embodiments 1, 2, 3, 4, 5, and 6. Moreover, in the following explanation, in an extension direction of an optical axis L, an object side is denoted as La, and an image side is denoted as Lb.

### Embodiment 1

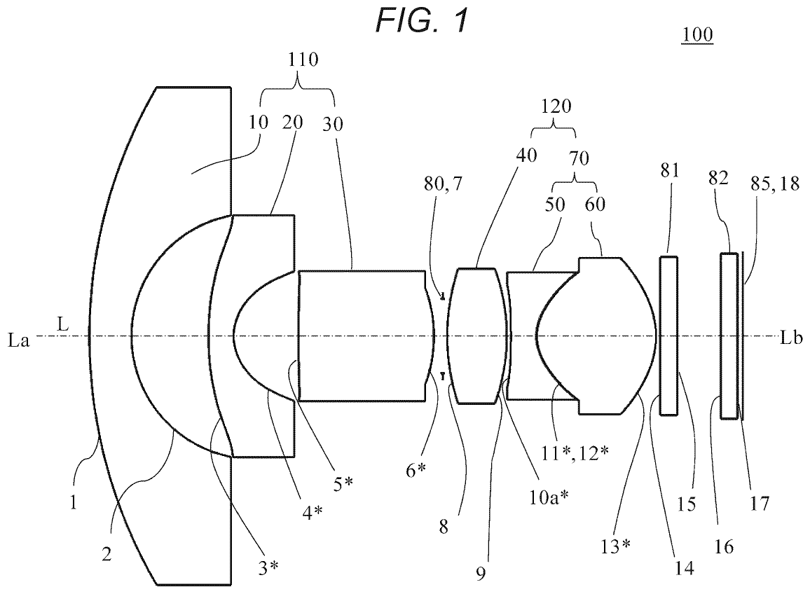

FIG. 1 is an explanatory diagram of a wide-angle lens 100 according to Embodiment 1 of the present invention. In addition, when surfaces are numbered in FIG. 1, aspheric surfaces are denoted as “*”. As shown in FIG. 1, the wide-angle lens 100 in this embodiment includes a front lens set 110, an aperture 80, and a rear lens set 120 in sequence from an object side La to an image side Lb. The front lens set 110 is composed of a first lens 10, a second lens 20, and a third lens 30 arranged in sequence from the object side La to the image side Lb. The rear lens set 120 is composed of a fourth lens 40, a fifth lens 50, and a sixth lens 60 arranged in sequence from the object side La to the image side Lb. For the sixth lens 60, a flat infrared cut-off filter 81, a translucent cover 82, and a shooting element 85 are arranged in sequence on the image side Lb.

The first lens 10 is a negative lens with a concave lens surface (second surface 2) facing the image side Lb (i.e., having negative focal power). The first lens 10 further has a convex lens surface (first surface 1) facing the object side La.

The second lens 20 is a negative lens with a concave lens surface (fourth surface 4) facing the image side Lb. The second lens 20 further has a convex lens surface (third surface 3) facing the object side La.

The third lens element 30 is a positive lens with a convex lens surface (sixth surface 6) facing the image side Lb (i.e., having positive focal power). The third lens element 30 further has a convex lens surface (fifth surface 5) facing the object side La.

The fourth lens 40 is a glass biconvex lens. The fourth lens 40 is a biconvex lens with a convex lens surface (eighth surface 8) facing the object side La and a convex lens surface (ninth surface 9) facing the image side Lb.

The fifth lens 50 is a lens with a concave lens surface (eleventh surface 11) facing the image side Lb. The fifth lens 50 further has a concave lens surface (tenth surface 10a) facing the object side La.

The sixth lens 60 is a biconvex lens. The sixth lens 60 is a biconvex lens with a convex lens surface (twelfth surface 12) facing the object side La and a convex lens surface (thirteenth surface 13) facing the image side Lb.

The fifth lens 50 and the sixth lens 60 constitute a compound lens 70, in which the image-side Lb lens surface of the fifth lens 50 and the object-side La lens surface of the sixth lens 60 are bonded by an adhesive (not shown).

The aperture 80 constitutes a seventh surface 7. The object-side La surface of the infrared cut-off filter 81 constitutes a fourteenth surface 14, and the image-side Lb surface of the infrared cut-off filter 81 constitutes a fifteenth surface 15. The object-side La surface of the cover 82 constitutes a sixteenth surface 16, and the image-side Lb surface of the cover 82 constitutes a seventeenth surface 17. A shooting surface of the shooting element 85 constitutes an eighteenth surface 18.

The second lens 20, the third lens 30, the fifth lens 50, and the sixth lens 60 are plastic lenses made of acrylic resin, polycarbonate, polyolefin, etc. Thus, low cost can be achieved. In this embodiment, the first lens 10 is a glass lens. In this embodiment, the lens surfaces on both sides of the second lens 20, the lens surfaces on both sides of the third lens 30, the lens surfaces on both sides of the fifth lens 50, and the lens surfaces on both sides of the sixth lens 60 are aspheric surfaces. The lens surfaces on both sides of the first lens 10 and the lens surfaces on both sides of the fourth lens 40 are spherical surfaces.

### (Lens Structure)

The structures of the lenses of the wide-angle lens 100 in this embodiment are shown in Tables 1-1 to 1-4. In Tables 1-1 to 1-4, the following characteristics are shown as the characteristics of the wide-angle lens 100. In addition, the values shown in Tables 1-1 to 1-4 and the subsequent tables are rounded to decimal places.
Total focal length f0 of the lens system (Effective Focal Length)
Total object-image distance d0 of the lens system (Total Track)
Total F value of the lens system (Image Space)
Maximum field of angle (Max. Field of Angle)
Pupil diameter
Total length from the first lens to the sixth lens (L1R1-L6R2 Track)
Maximum height of image (HOI)

In addition, Tables 1-1 to 1-4 show the following items on each surface. The units of curvature radius, thickness, and focal length are mm. Here, when the lens surface is a convex surface protruding towards the object side or a concave surface recessed towards the object side, the curvature radius is positive; and when the lens surface is a convex surface protruding towards the image side or a concave surface recessed towards the image side, the curvature radius is negative.
Curvature radius (Radius)
Thickness
Refractive index Nd
Abbe number vd
Focal length f
Lens radius (Semi-D)

In addition, Tables 1-1 to 1-4 show aspheric coefficients A4, A6, A8, A10, A12, A14, and A16 when the following equation (mathematical expression 1) shows the shapes of the aspheric surfaces. In the following equation, the sag (optical axis direction) is denoted as z, the height perpendicular to the optical axis (ray height) is denoted as r, the cone coefficient is denoted as k, and the reciprocal of curvature radius is denoted as c.

$$Z = \frac{c {r}^{2}}{1 + \sqrt{1 - ( 1 + K ) {c}^{2} {r}^{2}}} + {\sum }_{n = 2}^{5} {A}_{2 n} {r}^{2 n} \qquad [ Mathematical expession 1 ]$$

TABLE 1-1

| Effective Focal Length | 0.958 | mm |
|---|---|---|
| Total Track | 15.500 | mm |
| Image Space F/# | 2.000 | |
| Max. Field of Angle | 101 | deg |
| Pupil Diameter | 0.479 | |
| L1R1-L6R2 Track | 13.445 | mm |

| | |
|---|---|
| HOI | 1.970 |

TABLE 1-2

| Surface | Radius | Thickness | Nd | vd | f | semi-D |
|---|---|---|---|---|---|---|
| 1 | 11.700 | 1.000 | 1.804 | 46.50 | −5.097 | 5.898 |
| 2 | 2.920 | 1.825 | | | | 2.865 |
| 3* | 6.298 | 0.600 | 1.536 | 55.65 | −2.869 | 2.865 |
| 4* | 1.194 | 1.535 | | | | 1.541 |
| 5* | 29.121 | 3.216 | 1.639 | 23.03 | 4.869 | 1.541 |
| 6* | −3.333 | 0.210 | | | | 1.136 |
| 7 (aperture) | infinity | 0.107 | | | | 0.885 |
| 8 | 5.100 | 1.410 | 1.589 | 61.25 | 4.386 | 1.600 |
| 9 | −4.700 | 0.100 | | | | 1.600 |
| 10* | −24.199 | 0.600 | 1.639 | 23.03 | −1.569 | 1.246 |
| 11* | 1.056 | 0.015 | 1.486 | 56.09 | | 1.515 |
| 12* | 1.056 | 2.827 | 1.536 | 55.65 | 1.903 | 1.531 |
| 13* | −1.928 | 0.100 | | | | 1.855 |
| 14 | infinity | 0.400 | 1.517 | 64.197 | | |
| 15 | infinity | 1.030 | | | | |
| 16 | infinity | 0.400 | 1.517 | 64.197 | | |
| 17 | infinity | 0.125 | | | | |

TABLE 1-3

| Surface | c (1/Radius) | K | A4 | A6 | A8 | A10 |
|---|---|---|---|---|---|---|
| 3 | 0.158780565 | −1 | −1.39805E−03 | 6.10690E−04 | 2.31167E−04 | −9.05466E−05 |
| 4 | 0.837520938 | −1 | 2.20888E−02 | 4.11778E−02 | −3.55308E−02 | 2.55921E−02 |
| 5 | 0.03433948 | 1 | −3.81735E−04 | −2.85622E−03 | −6.95573E−04 | 7.74613E−03 |
| 6 | −0.300030003 | −1 | 5.89066E−03 | −5.99373E−02 | 1.59143E−01 | −2.44044E−01 |
| 10 | −0.041324022 | 1 | −2.77346E−02 | −1.71949E−02 | 6.31006E−02 | −1.11246E−01 |
| 11 | 0.946969697 | −1 | −4.78425E−02 | 3.54052E−02 | −5.24811E−02 | 4.54539E−02 |
| 12 | 0.946969697 | −1 | −4.78425E−02 | 3.54052E−02 | −5.24811E−02 | 4.54539E−02 |
| 13 | −0.518672199 | −1 | 1.43143E−02 | −9.13509E−03 | 4.62418E−03 | −1.29796E−03 |

TABLE 1-4

| Surface | A12 | A14 | A16 |
|---|---|---|---|
| 3 | 9.17277E−06 | −3.25577E−07 | 1.16383E−09 |
| 4 | −7.85683E−03 | 1.85484E−03 | −4.11236E−04 |
| 5 | −8.27567E−03 | 3.62582E−03 | −6.12369E−04 |
| 6 | 2.13424E−01 | −9.86691E−02 | 1.84518E−02 |
| 10 | 1.06962E−01 | −5.27847E−02 | 1.05737E−02 |
| 11 | −2.00980E−02 | 4.77819E−03 | −5.00164E−04 |
| 12 | −2.00980E−02 | 4.77819E−03 | −5.00164E−04 |
| 13 | 1.60325E−04 | 3.86056E−07 | −2.18236E−06 |

As shown in Tables 1-1 to 1-4, in the wide-angle lens 100 of this embodiment, the total focal length f0 of the lens system is 0.958 mm; the distance between the object-side La lens surface of the first lens 10 and the shooting element 85, i.e., the total object-image distance do of the lens system, is 15.500 mm; the total F value of the lens system is 2.000, the maximum field of angle is 101 deg, the pupil diameter is 0.479 mm, the total length from the first lens to the sixth lens is 13.445 mm, and the maximum height of image is 1.970 mm.

### (Aberration Characteristics of the Wide-Angle Lens 100)

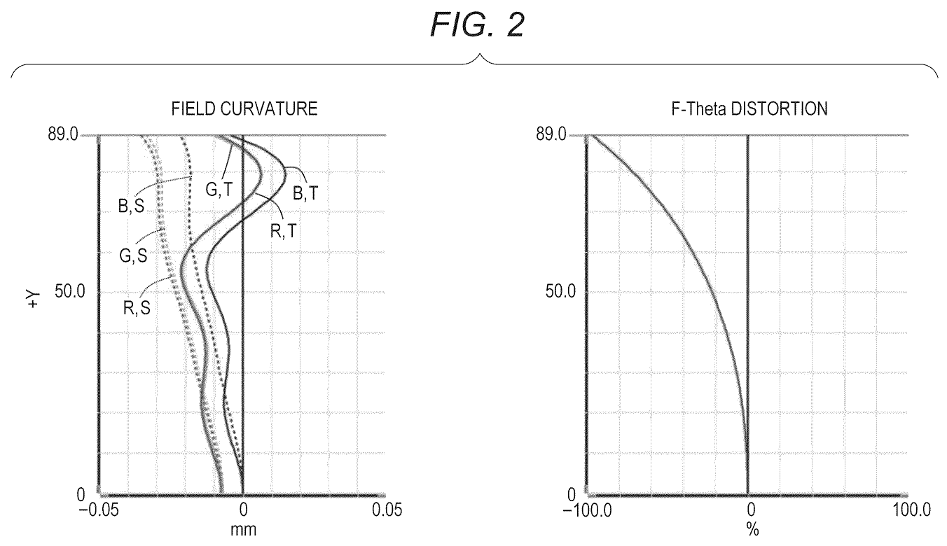

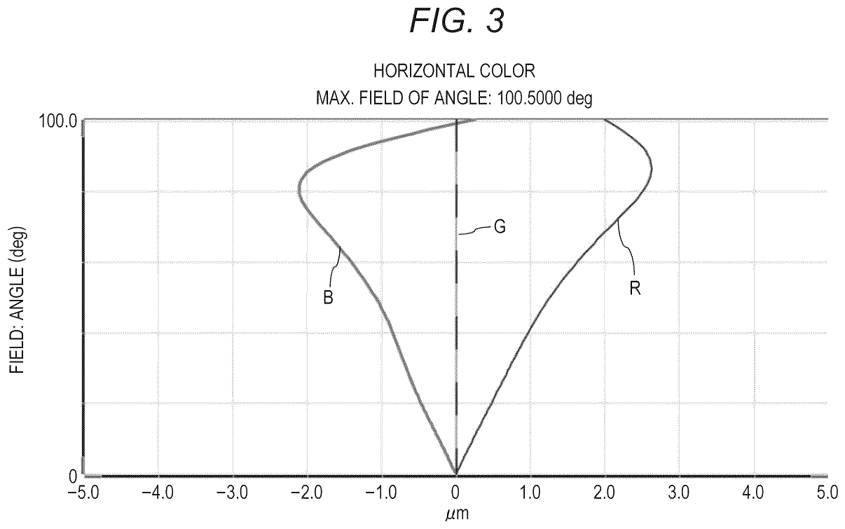

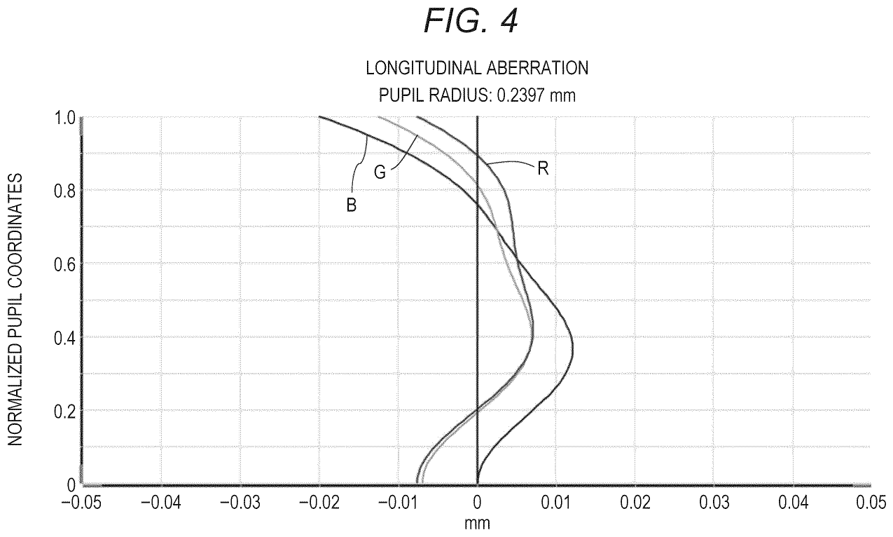

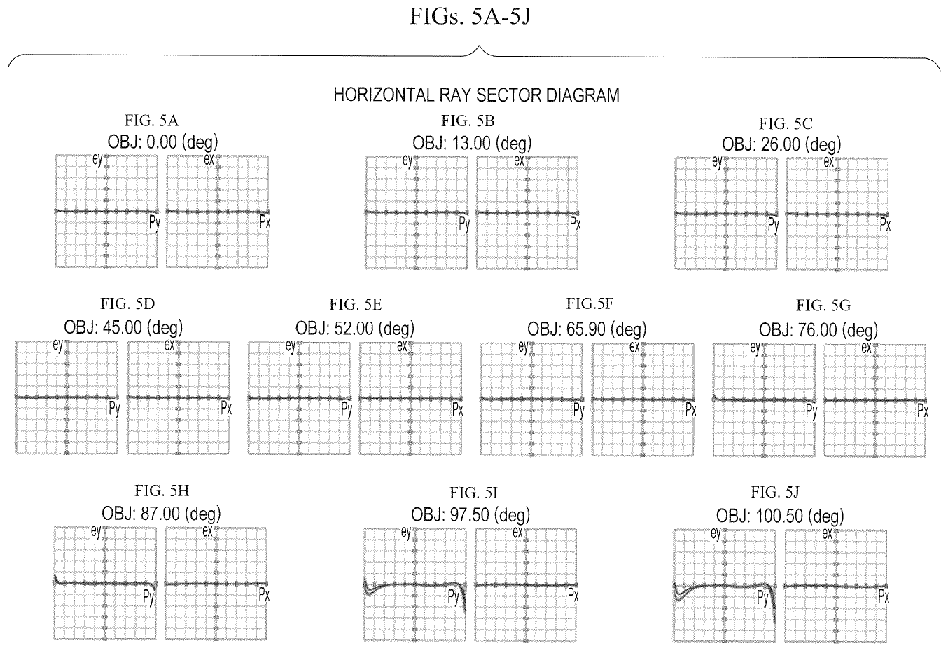

FIG. 2 is an explanatory diagram illustrating the astigmatism and distortion of the wide-angle lens 100 shown in FIG. 1. FIG. 3 is an explanatory diagram illustrating the chromatic aberration of magnification of the wide-angle lens 100 shown in FIG. 1, indicating the chromatic aberration of magnification at the maximum field angle (100.5000 deg/half angle). FIG. 4 is an explanatory diagram illustrating the spherical aberration of the wide-angle lens 100 shown in FIG. 1. FIGS. 5A to 5J are explanatory diagrams illustrating lateral aberrations of the wide-angle lens 100 shown in FIG. 1, where FIG. 5A, FIG. 5B, FIG. 5C, FIG. 5D, FIG. 5E, FIG. 5F, FIG. 5G, FIG. 5H, FIG. 5I, and FIG. 5J illustrate lateral aberrations in a tangential direction (Y direction) and a radial direction (X direction) at angles of 0.00°, 13.00°, 26.00°, 45.00°, 52.00°, 65.90°, 76.00°, 87.00°, 97.50°, and 100.50° relative to the optical axis.

Moreover, in FIG. 2 to FIG. 4, the aberrations at wavelengths of 486 nm, 588 nm, and 656 nm are denoted as B, G, and R. Regarding the astigmatism shown in FIG. 2, the characteristic in the radial direction is denoted as S, and the characteristic in the tangential direction is denoted as T. In addition, the distortion shown in FIG. 2 represents a rate of change between images at the center and the periphery of the shot. It can be considered that the smaller the absolute value of the distortion, the higher the precision of the lens.

As shown in FIG. 2 to FIGS. 5A to 5J, in the wide-angle lens 100 of this embodiment, the astigmatism (distortion), chromatic aberration of magnification, spherical aberration, and lateral aberration are corrected to appropriate levels.

### (Regarding the Structure of Countermeasures for the Shift of a Focus Position)

Table 2 shows values corresponding to conditional expressions described below, and Table 2 also shows values of Embodiments 2-6 described later.

TABLE 2

| | | Embodiment | Embodiment | Embodiment | Embodiment | Embodiment | Embodiment |
|---|---|---|---|---|---|---|---|
| Condition | | 1 | 2 | 3 | 4 | 5 | 6 |
| (1) | 3.000 < d0/f4 < 4.000 | 3.534 | 3.485 | 3.472 | 3.586 | 3.331 | 3.392 |
| (2) | 3.500 < f4/f0 < 5.500 | 4.578 | 4.637 | 4.637 | 4.507 | 4.862 | 4.759 |
| (3) | −7.500 < R42/f0 < −3.500 | −4.906 | −7.299 | −4.676 | −4.789 | −3.572 | −4.544 |
| (4) | 2.000 < T3/f0 < 4.000 | 3.357 | 3.421 | 3.429 | 3.302 | 3.310 | 3.292 |
| (5) | 2.000 < d0/sd11 < 3.000 | 2.628 | 2.628 | 2.671 | 2.563 | 2.626 | 2.628 |
| (6) | 5.000 < d0/HOI < 10.000 | 7.868 | 7.868 | 7.869 | 7.868 | 7.868 | 7.866 |
| (7) | 180° < ω < 210° | 101 | 101 | 101 | 101 | 101 | 101 |
| (8) | 13.000 < d0/f0 < 18.000 | 16.180 | 16.163 | 16.097 | 16.163 | 16.195 | 16.143 |

As shown in Tables 1-1 to 1-4 and Table 2, when the total object-image distance of the lens system is denoted as do and the focal length of the fourth lens 40 is denoted as f4, the following conditional expression (1) is satisfied:

$$3. < d 0 / f 4 < 4. . \qquad conditional expression ( 1 )$$

In this condition, preferably, 3.331<d0/f4<3.586 . . . conditional expression (1a).

More specifically, the total object-image distance d0 of the lens system is 15.500 mm, and the focal length f4 of the fourth lens 40 is 4.386 mm. Therefore, the ratio (d0/f4) is 3.534, satisfying the conditional expression (1).

Because the ratio (d0/f4) is more than the lower limit (3.000), the shift of the focus position with changes in ambient temperature can be appropriately eliminated based on the fourth lens. In addition, because the ratio (d0/f4) is less than the upper limit (4.000), excessive elimination on the shift of the focus position with changes in ambient temperature based on the fourth lens can be prevented.

When the total focal length of the lens system is denoted as f0, the following conditional expression (2) is satisfied:

$$3.5 < f 4 / f 0 < 5.5 . \qquad conditional expression ( 2 )$$

More specifically, the focal length f4 of the fourth lens 40 is 4.386 mm, and the total focal length f0 of the lens system is 0.958 mm. Therefore, the ratio (f4/f0) is 4.578, satisfying the conditional expression (2).

In this condition, preferably, 4.000<f4/f0<5.000 . . . conditional expression (2a).

Because the ratio (f4/f0) is more than the lower limit (3.500), the shift of the focus position with changes in ambient temperature can be appropriately eliminated based on the fourth lens. In addition, because the ratio (f4/f0) is less than the upper limit (5.500), excessive elimination on the shift of the focus position with changes in ambient temperature based on the fourth lens can be prevented.

When the total focal length of the lens system is denoted as f0 and the curvature radius of the image-side lens surface of the fourth lens 40 is denoted as R42, the following conditional expression (3) is satisfied:

$$- 7.500 < R 42 / f 0 < - 3.5 . \qquad conditional expression ( 3 )$$

More specifically, the total focal length f0 of the lens system is 0.958 mm, and the curvature radius R42 of the image-side lens surface of the fourth lens 40 is −4.700 mm. Therefore, the ratio (R42/f0) is −4.906, satisfying the conditional expression (3).

Because the ratio (R42/f0) is more than the lower limit (−7.500), various aberrations can be appropriately corrected. In addition, because the upper limit (−3.500) is set for the ratio (R42/f0), the curvature radius R42 of the image-side lens surface of the fourth lens 40 can be suppressed from being too small. Therefore, the image-side lens surface of the fourth lens 40 can be easily formed.

When the total focal length of the lens system is denoted as f0 and the center thickness of the third lens 30 is denoted as T3, the following conditional expression (4) is satisfied:

$$2. 000 < T 3 / f 0 < 4 \text{.000} . \qquad conditional expression ( 4 )$$

More specifically, the total focal length f0 of the lens system is 0.958 mm, and the center thickness T3 of the third lens 30 is 3.216 mm. Therefore, the ratio (T3/f0) is 3.357, satisfying the conditional expression (4).

Because the ratio (T3/f0) is more than the lower limit (2.000), the balance between the chromatic aberrations of magnification generated by the first lens and the second lens and the chromatic aberration of magnification of the third lens that corrects the previous chromatic aberrations of magnification can be rationalized, and spherical aberration and coma aberration can be corrected. In addition, because the ratio (T3/f0) is less than the upper limit (4.000), the center thickness T3 of the third lens will not be unnecessarily too thick. Therefore, the total object-image distance of the lens can be shortened.

When the effective radius of the object-side lens surface of the first lens 10 is denoted as sd11, the following conditional expression (5) is satisfied:

$$2. 000 < d 0 / sd 11 < 3. . \qquad conditional expression ( 5 )$$

More specifically, the total object-image distance do of the lens system is 15.500 mm, and the effective radius sd11 of the object-side lens surface of the first lens 10 is 5.898 mm. Therefore, the ratio (d0/sd11) is 2.628, satisfying the conditional expression (5).

Because the ratio (d0/sd11) is more than the lower limit (2.000), an increase in the diameter of the first lens 10 can be avoided. Therefore, miniaturization of the wide-angle lens (in the radial direction) can be achieved. In addition, because the ratio (d0/sd11) is less than the upper limit (3.000), an increase in the total length of the lens system can be avoided. Therefore, miniaturization of the wide-angle lens (in the optical axis direction) can be achieved. Alternatively, the diameter of the first lens 10 will not be too small. Therefore, peripheral illumination can be ensured (darkening can be avoided).

When the maximum height of image is denoted as HOI, the following conditional expression (6) is satisfied:

$$5. 000 < d 0 / HOI < 10. . \qquad conditional expression ( 6 )$$

More specifically, the total object-image distance d0 of the lens system is 15.500 mm, and the maximum height of image is 1.970 mm. Therefore, the ratio (d0/HOI) is 7.868, satisfying the conditional expression (6).

Because the ratio (d0/HOI) is more than the lower limit (5.000), various aberrations can be effectively corrected. In addition, because the ratio (d0/HOI) is less than the upper limit (10.000), an increase in the total length of the lens can be avoided. Therefore, miniaturization of the wide-angle lens (in the optical axis direction) can be achieved.

When the full field of angle of the wide-angle lens 100 is denoted as w, the following conditional expression (7) is satisfied:

$$180 ° < ω < 210 ° . \qquad conditional expression ( 7 )$$

More specifically, the full field of angle ω of the wide-angle lens 100 is 101°. Therefore, the conditional expression (7) is satisfied.

Because ω is more than the lower limit (180°), a wide angle can be achieved. In addition, because ω is less than the upper limit (210°), the peripheral illumination can be prevented from falling off compared to the center, and the periphery of an image can be prevented from darkening.

When the total focal length of the lens system is denoted as f0, the following conditional expression (8) is satisfied:

$$13. 000 < d 0 / f 0 < 18. . \qquad conditional expression ( 8 )$$

More specifically, the total object-image distance d0 of the lens system is 15.500 mm, and the total focal length f0 of the lens system is 0.958 mm. Therefore, the ratio (d0/f0) is 16.180, satisfying the conditional expression (8).

Because the ratio (d0/f0) is more than the lower limit (13.000), spherical aberration and distortion aberration can be appropriately corrected. In addition, because the ratio (d0/f0) is less than the upper limit (18.000), an excessive increase in lens diameter can be suppressed, and an increase in the total length of the lens system can be avoided.

The wide-angle lens of the present invention is applicable in a temperature range of −40° C. to 105° C., for example.

### Embodiment 2

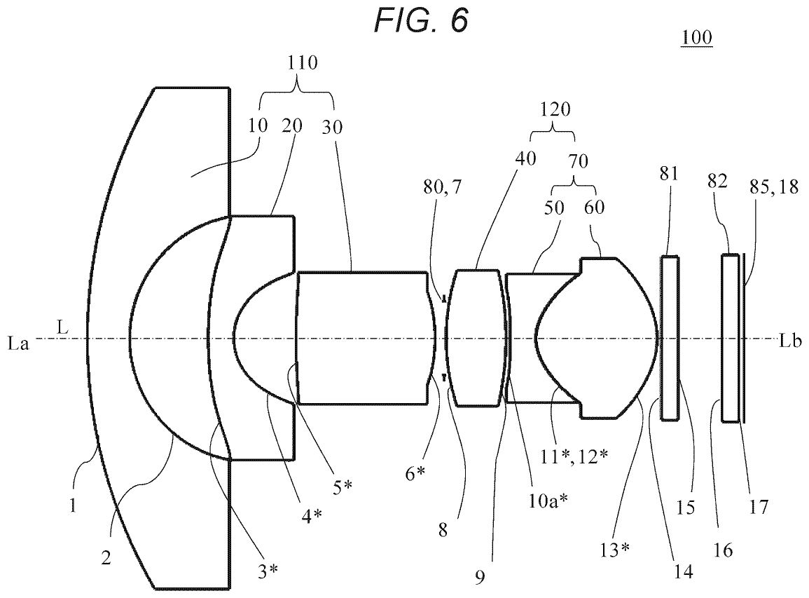

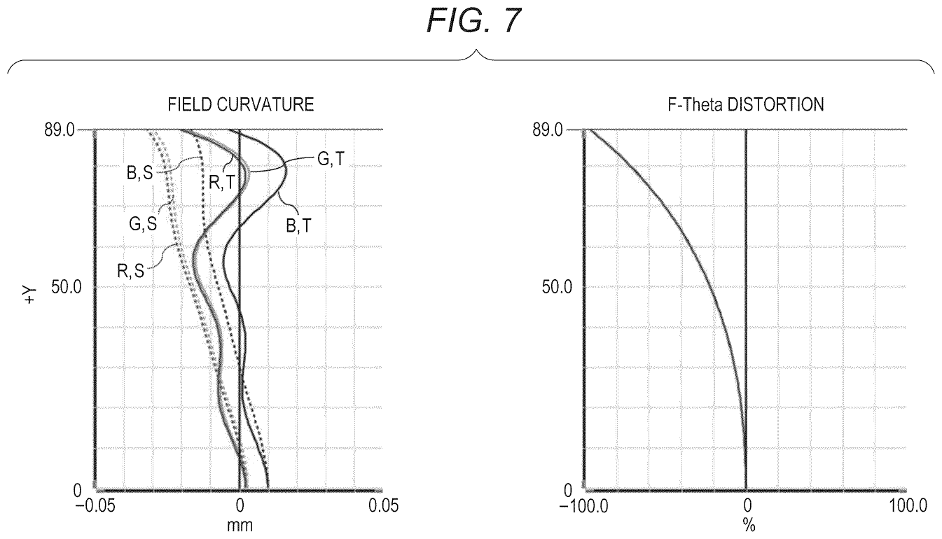

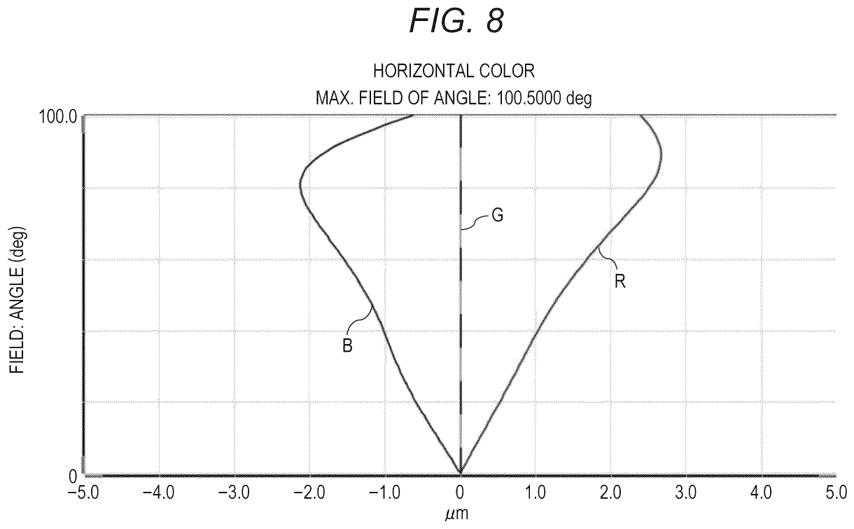

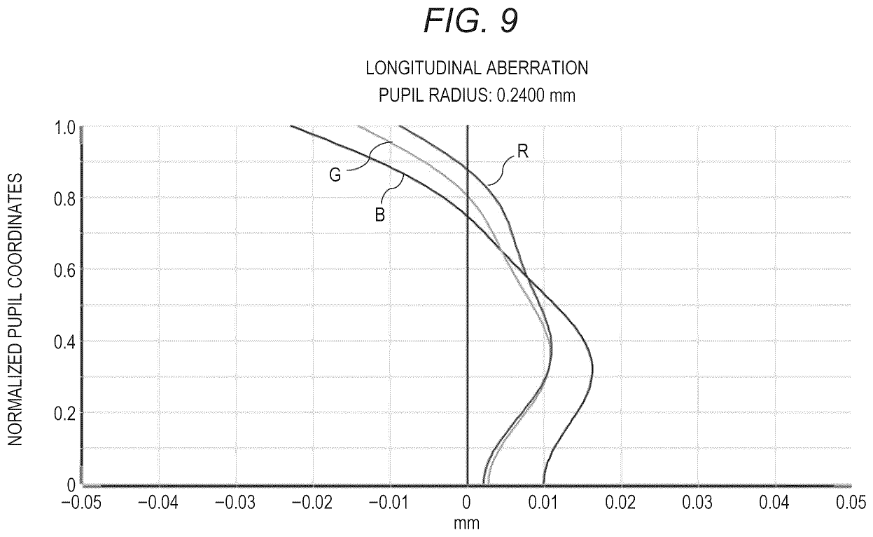

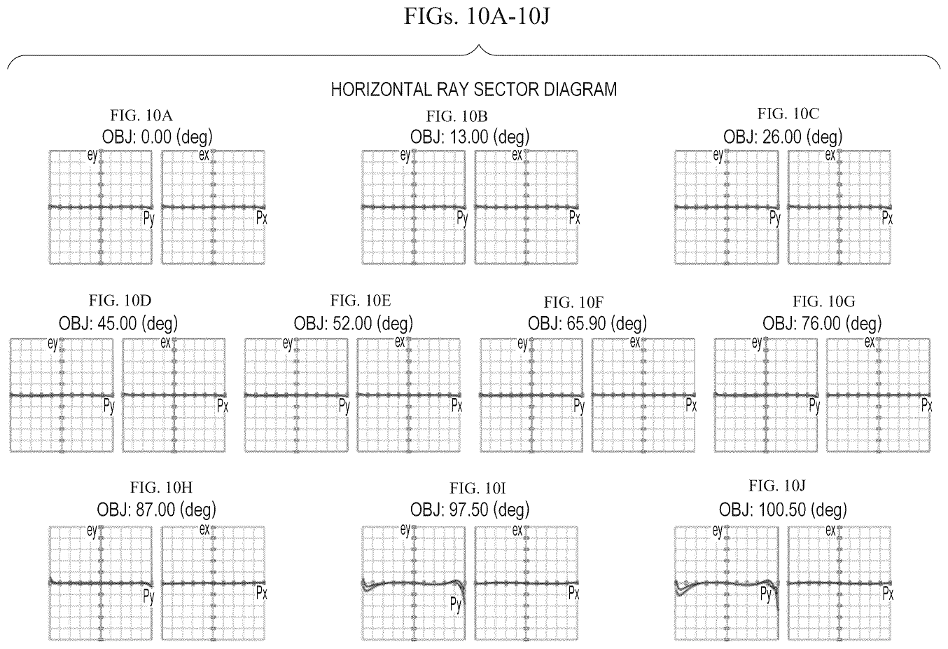

FIG. 6 is an explanatory diagram of a wide-angle lens 100 according to Embodiment 2 of the present invention. FIG. 7 is an explanatory diagram illustrating the astigmatism and distortion of the wide-angle lens 100 shown in FIG. 6. FIG. 8 is an explanatory diagram illustrating the chromatic aberration of magnification of the wide-angle lens 100 shown in FIG. 6, indicating the chromatic aberration of magnification at the maximum field angle (100.5000 deg/half angle). FIG. 9 is an explanatory diagram illustrating the spherical aberration of the wide-angle lens 100 shown in FIG. 6. FIGS. 10A to 10J explanatory diagrams illustrating lateral aberrations of the wide-angle lens 100 shown in FIG. 6, where FIG. 10A, FIG. 10B, FIG. 10C, FIG. 10D, FIG. 10E, FIG. 10F, FIG. 10G, FIG. 10H, FIG. 10I, and FIG. 10J illustrate lateral aberrations in a tangential direction (Y direction) and a radial direction (X direction) at angles of 0.00°, 13.00°, 26.00°, 45.00°, 52.00°, 65.90°, 76.00°, 87.00°, 97.50°, and 100.50° relative to the optical axis.

As shown in FIG. 6, the wide-angle lens 100 in this embodiment, like Embodiment 1, also includes a front lens set 110, an aperture 80, and a rear lens set 120 in sequence from an object side La to an image side Lb. The front lens set 110 is composed of a first lens 10, a second lens 20, and a third lens 30 arranged in sequence from the object side La to the image side Lb. The rear lens set 120 is composed of a fourth lens 40, a fifth lens 50, and a sixth lens 60 arranged in sequence from the object side La to the image side Lb.

The structures of the lenses of the wide-angle lens 100 in this embodiment are shown in Tables 3-1 to 3-4. In the wide-angle lens 100 of this embodiment, the total focal length f0 of the lens system is 0.959 mm, the total object-image distance d0 of the lens system is 15.500 mm, the total F value of the lens system is 2.000, the maximum field of angle is 101 deg, the pupil diameter is 0.480 mm, the total length from the first lens to the sixth lens is 13.446 mm, and the maximum height of image is 1.970 mm. As shown in FIG. 7 to FIGS. 10A to 10J, in the wide-angle lens 100 of this embodiment, the astigmatism (distortion), chromatic aberration of magnification, spherical aberration, and lateral aberration are corrected to appropriate levels.

TABLE 3-1

| Effective Focal Length | 0.959 | mm |
|---|---|---|
| Total Track | 15.500 | mm |
| Image Space F/# | 2.000 | |
| Max. Field of Angle | 101 | deg |
| Pupil Diameter | 0.480 | |
| L1R1-L6R2 Track | 13.446 | mm |

TABLE 3-2

| Surface | Radius | Thickness | Nd | vd | f | semi-D |
|---|---|---|---|---|---|---|
| 1 | 11.700 | 1.000 | 1.804 | 46.50 | −5.097 | 5.897 |
| 2 | 2.920 | 1.853 | | | | 2.865 |
| 3* | 8.200 | 0.600 | 1.536 | 55.65 | −2.883 | 2.865 |
| 4* | 1.266 | 1.473 | | | | 1.547 |
| 5* | 16.713 | 3.281 | 1.639 | 23.03 | 4.907 | 1.547 |
| 6* | −3.564 | 0.210 | | | | 1.104 |
| 7 (aperture) | infinity | 0.050 | | | | 0.864 |
| 8 | 5.100 | 1.410 | 1.697 | 55.46 | 4.447 | 1.600 |
| 9 | −7.000 | 0.100 | | | | 1.600 |
| 10* | −25.099 | 0.600 | 1.639 | 23.03 | −1.511 | 1.183 |
| 11* | 1.014 | 0.015 | 1.486 | 56.09 | | 1.511 |
| 12* | 1.014 | 2.853 | 1.536 | 55.65 | 1.873 | 1.539 |
| 13* | −1.783 | 0.100 | | | | 1.877 |
| 14 | infinity | 0.400 | 1.517 | 64.197 | | |
| 15 | infinity | 1.029 | | | | |
| 16 | infinity | 0.400 | 1.517 | 64.197 | | |
| 17 | infinity | 0.125 | | | | |

TABLE 3-3

| Surface | c (1/Radius) | K | A4 | A6 | A8 | A10 |
|---|---|---|---|---|---|---|
| 3 | 0.12194632 | −1 | 1.20104E−03 | 4.20262E−04 | 2.03189E−04 | −8.68237E−05 |
| 4 | 0.789759509 | −1 | 2.24622E−02 | 4.29977E−02 | −3.62494E−02 | 2.55060E−02 |
| 5 | 0.059835147 | 1 | 1.89804E−03 | −4.84150E−03 | 8.96703E−04 | 7.54022E−03 |
| 6 | −0.28058655 | −1 | 5.54389E−04 | −5.30278E−02 | 1.47826E−01 | −2.35013E−01 |
| 10 | −0.03984292 | 1 | −3.53359E−02 | −1.52453E−02 | 6.23046E−02 | −1.10548E−01 |
| 11 | 0.986602304 | −1 | −6.17711E−02 | 4.05400E−02 | −4.22028E−02 | 3.87366E−02 |
| 12 | 0.986602304 | −1 | −6.17711E−02 | 4.05400E−02 | −4.22028E−02 | 3.87366E−02 |
| 13 | −0.560859847 | −1 | 1.57853E−02 | −9.69643E−03 | 4.57934E−03 | −1.32750E−03 |

TABLE 3-4

| Surface | A12 | A14 | A16 |
|---|---|---|---|
| 3 | 9.28909E−06 | −2.70234E−07 | −6.63498E−09 |
| 4 | −7.58805E−03 | 1.61796E−03 | −3.29516E−04 |
| 5 | −8.48554E−03 | 3.62904E−03 | −5.84709E−04 |
| 6 | 2.09752E−01 | −9.73446E−02 | 1.79729E−02 |
| 10 | 1.06752E−01 | −5.34668E−02 | 1.11014E−02 |
| 11 | −2.13535E−02 | 6.93545E−03 | −1.00225E−03 |
| 12 | −2.13535E−02 | 6.93545E−03 | −1.00225E−03 |
| 13 | 1.66458E−04 | 1.83311E−06 | −2.86901E−06 |

As shown in Table 2, because the wide-angle lens 100 of this embodiment satisfies the conditional expressions (1), (2), (3), (4), (5), (6), (7), and (8) described in Embodiment 1, the same effects as Embodiment 1 can be achieved.

More specifically, the total object-image distance do of the lens system is 15.500 mm, and the focal length f4 of the fourth lens 40 is 4.447 mm. Therefore, the ratio (d0/f4) is 3.485, satisfying the conditional expression (1).

More specifically, the focal length f4 of the fourth lens 40 is 4.447 mm, and the total focal length f0 of the lens system is 0.959 mm. Therefore, the ratio (f4/f0) is 4.637, satisfying the conditional expression (2).

More specifically, the total focal length f0 of the lens system is 0.959 mm, and the curvature radius R42 of the image-side lens surface of the fourth lens 40 is −7.000 mm. Therefore, the ratio (R42/f0) is −7.299, satisfying the conditional expression (3).

More specifically, the total focal length f0 of the lens system is 0.959 mm, and the center thickness T3 of the third lens 30 is 3.281 mm. Therefore, the ratio (T3/f0) is 3.421, satisfying the conditional expression (4).

More specifically, the total object-image distance do of the lens system is 15.500 mm, and the effective radius sd11 of the lens surface of the first lens 10 that faces the object side is 5.897 mm. Therefore, the ratio (d0/sd11) is 2.628, satisfying the conditional expression (5). More specifically, the total object-image distance d0 of the lens system is 15.500 mm, and the maximum height of image is 1.970 mm. Therefore, the ratio (d0/HOI) is 7.868, satisfying the conditional expression (6).

More specifically, the full field of angle ω of the wide-angle lens 100 is 101°. Therefore, the conditional expression (7) is satisfied.

More specifically, the total object-image distance d0 of the lens system is 15.500 mm, and the total focal length f0 of the lens system is 0.959 mm. Therefore, the ratio (d0/f0) is 16.163, satisfying the conditional expression (8).

### Embodiment 3

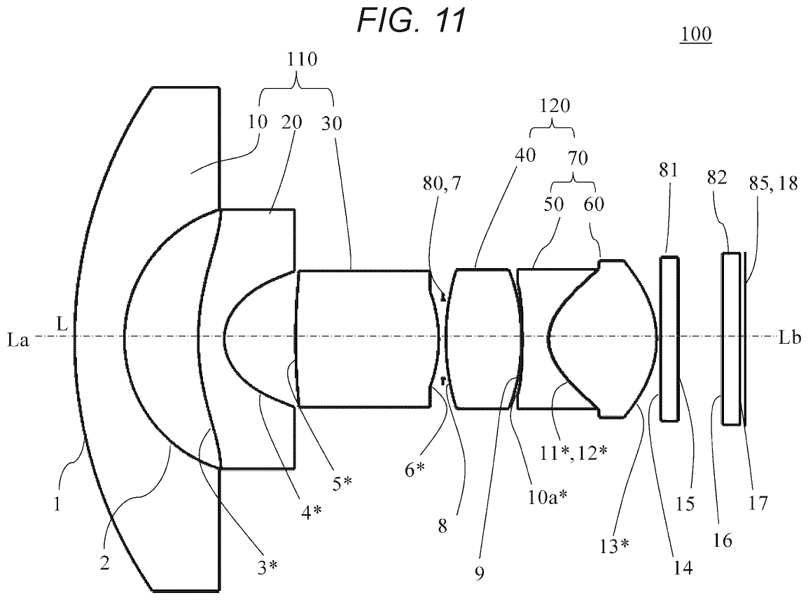

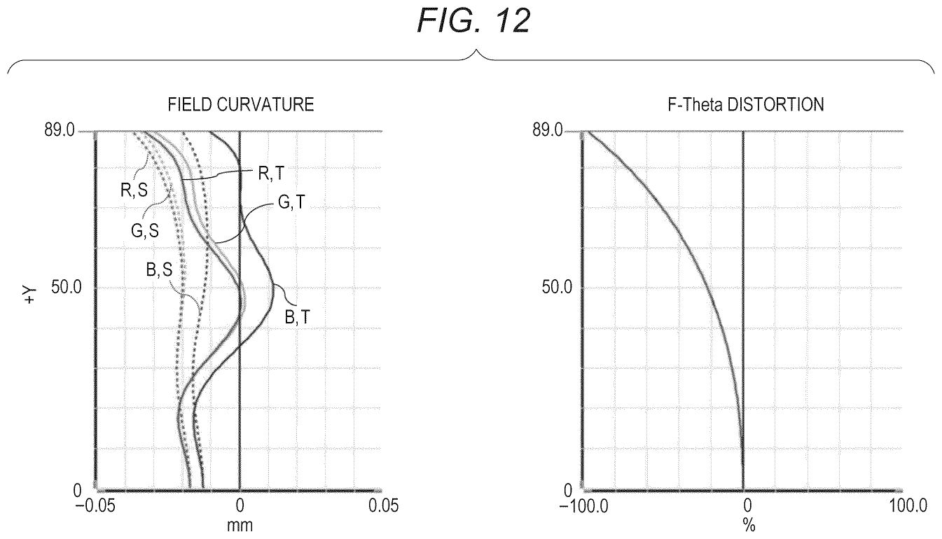

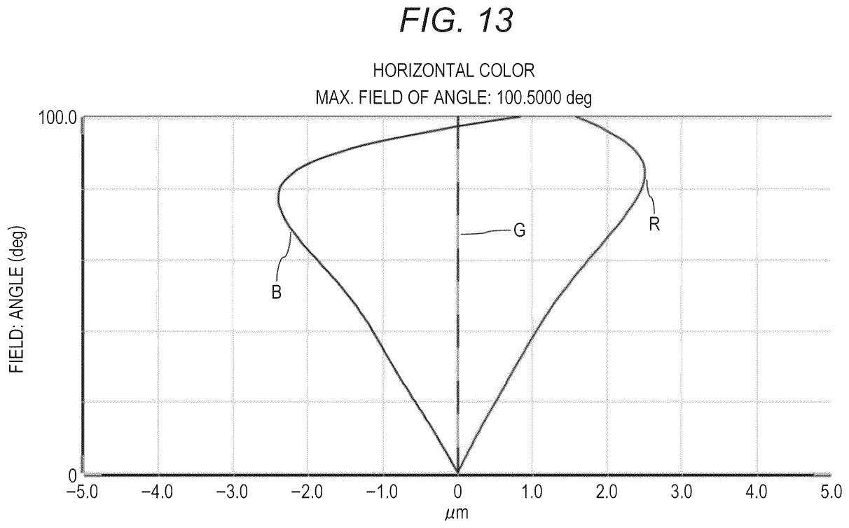

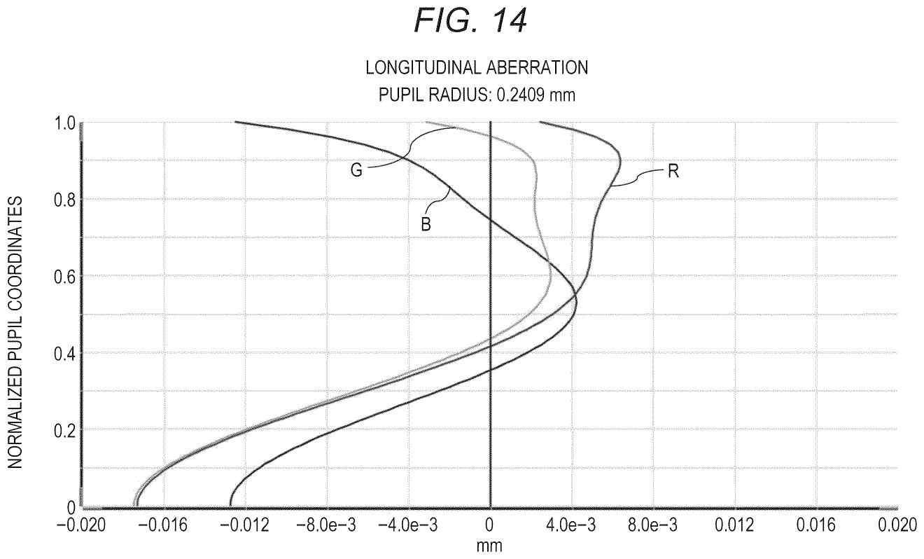

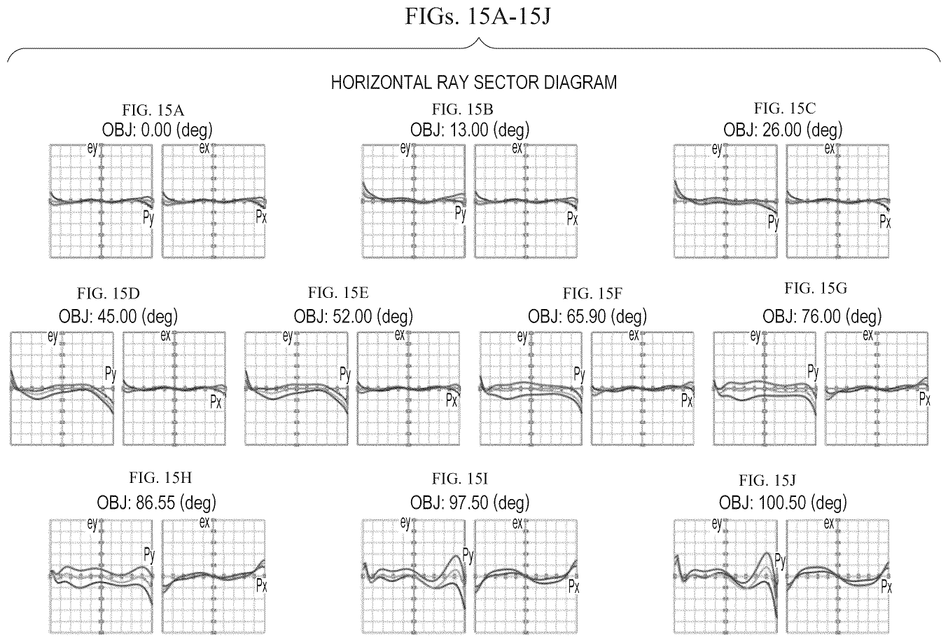

FIG. 11 is an explanatory diagram of a wide-angle lens 100 according to Embodiment 3 of the present invention. FIG. 12 is an explanatory diagram illustrating the astigmatism and distortion of the wide-angle lens 100 shown in FIG. 11. FIG. 13 is an explanatory diagram illustrating the chromatic aberration of magnification of the wide-angle lens 100 shown in FIG. 11, indicating the chromatic aberration of magnification at the maximum field angle (100.5000 deg/half angle). FIG. 14 is an explanatory diagram illustrating the spherical aberration of the wide-angle lens 100 shown in FIG. 11. FIGS. 15A to 15J explanatory diagrams illustrating lateral aberrations of the wide-angle lens 100 shown in FIG. 11, where FIG. 15A, FIG. 15B, FIG. 15C, FIG. 15D, FIG. 15E, FIG. 15F, FIG. 15G, FIG. 15H, FIG. 15I, and FIG. 15J illustrate lateral aberrations in a tangential direction (Y direction) and a radial direction (X direction) at angles of 0.00°, 13.00°, 26.00°, 45.00°, 52.00°, 65.90°, 76.00°, 86.55°, 97.50°, and 100.50° relative to the optical axis.

As shown in FIG. 11, the wide-angle lens 100 in this embodiment, like Embodiment 1, also includes a front lens set 110, an aperture 80, and a rear lens set 120 in sequence from an object side La to an image side Lb. The front lens set 110 is composed of a first lens 10, a second lens 20, and a third lens 30 arranged in sequence from the object side La to the image side Lb. The rear lens set 120 is composed of a fourth lens 40, a fifth lens 50, and a sixth lens 60 arranged in sequence from the object side La to the image side Lb.

The structures of the lenses of the wide-angle lens 100 in this embodiment are shown in Tables 4-1 to 4-4. In the wide-angle lens 100 of this embodiment, the total focal length f0 of the lens system is 0.963 mm, the total object-image distance d0 of the lens system is 15.501 mm, the total F value of the lens system is 2.000, the maximum field of angle is 101 deg, the pupil diameter is 0.481 mm, the total length from the first lens to the sixth lens is 13.448 mm, and the maximum height of image is 1.970 mm. As shown in FIG. 12 to FIGS. 15A to 15J, in the wide-angle lens 100 of this embodiment, the astigmatism (distortion), chromatic aberration of magnification, spherical aberration, and lateral aberration are corrected to appropriate levels.

TABLE 4-1

| Effective Focal Length | 0.963 | mm |
|---|---|---|
| Total Track | 15.501 | mm |
| Image Space F/# | 2.000 | |
| Max. Field of Angle | 101 | deg |
| Pupil Diameter | 0.481 | |
| L1R1-L6R2 Track | 13.448 | mm |

| | |
|---|---|
| HOI | 1.970 |

TABLE 4-2

| Surface | Radius | Thickness | Nd | vd | f | semi-D |
|---|---|---|---|---|---|---|
| 1 | 10.254 | 1.150 | 1.954 | 32.32 | −5.115 | 5.803 |
| 2 | 3.125 | 1.706 | | | | 2.984 |
| 3* | 5.165 | 0.600 | 1.536 | 55.65 | −2.650 | 2.984 |
| 4* | 1.068 | 1.655 | | | | 1.567 |
| 5* | 17.393 | 3.302 | 1.639 | 23.03 | 4.364 | 1.567 |
| 6* | −3.075 | 0.100 | | | | 1.102 |
| 7 (aperture) | infinity | 0.066 | | | | 0.910 |
| 8 | 5.416 | 1.750 | 1.589 | 61.25 | 4.465 | 1.600 |
| 9 | −4.503 | 0.016 | | | | 1.600 |
| 10* | −23.272 | 0.600 | 1.639 | 23.03 | −1.408 | 1.286 |
| 11* | 0.945 | 0.015 | 1.486 | 56.09 | | 1.614 |
| 12* | 0.945 | 2.488 | 1.536 | 55.65 | 1.703 | 1.623 |
| 13* | −2.127 | 0.100 | | | | 1.808 |
| 14 | infinity | 0.400 | 1.517 | 64.197 | | |
| 15 | infinity | 1.028 | | | | |
| 16 | infinity | 0.400 | 1.517 | 64.197 | | |
| 17 | infinity | 0.125 | | | | |

TABLE 4-3

| Surface | c (1/Radius) | K | A4 | A6 | A8 | A10 |
|---|---|---|---|---|---|---|
| 3 | 0.193606521 | −1 | −3.06012E−03 | 2.37512E−04 | −5.75506E−05 | −9.23803E−07 |
| 4 | 0.936094827 | −1 | 2.73173E−02 | 3.90928E−02 | −1.93001E−02 | 6.60715E−03 |
| 5 | 0.057495769 | 1 | −2.50002E−03 | 4.18447E−03 | −1.26773E−03 | −8.49412E−05 |
| 6 | −0.325196864 | −1 | 2.71896E−03 | −1.36984E−02 | 1.26679E−02 | −4.50218E−03 |
| 10 | −0.042969941 | 1 | −2.33826E−02 | −8.81703E−03 | 1.47639E−02 | −1.80168E−02 |
| 11 | 1.057885942 | −1 | −3.75457E−04 | −3.91484E−02 | 1.76698E−02 | −2.66999E−03 |
| 12 | 1.057885942 | −1 | −3.75457E−04 | −3.91484E−02 | 1.76698E−02 | −2.66999E−03 |
| 13 | −0.47019916 | −1 | 4.90851E−03 | −4.28434E−03 | 6.78822E−04 | 5.50382E−04 |

TABLE 4-4

| Surface | A12 | A14 | A16 |
|---|---|---|---|
| 3 | 2.85244E−07 | −5.07074E−09 | 9.28317E−10 |
| 4 | 5.57909E−04 | −4.51753E−05 | −1.93668E−04 |
| 5 | 5.71330E−05 | 9.57024E−05 | −4.92762E−05 |
| 6 | 3.24787E−03 | −6.11786E−03 | 2.82663E−03 |
| 10 | 1.21628E−02 | −3.75845E−03 | 4.00706E−04 |
| 11 | −1.00394E−03 | 5.99985E−04 | −9.69381E−05 |
| 12 | −1.00394E−03 | 5.99985E−04 | −9.69381E−05 |
| 13 | −2.55875E−04 | 3.29392E−05 | 5.54267E−07 |

As shown in Table 2, because the wide-angle lens 100 of this embodiment satisfies the conditional expressions (1), (2), (3), (4), (5), (6), (7), and (8) described in Embodiment 1, the same effects as Embodiment 1 can be achieved.

More specifically, the total object-image distance do of the lens system is 15.501 mm, and the focal length f4 of the fourth lens 40 is 4.465 mm. Therefore, the ratio (d0/f4) is 3.472, satisfying the conditional expression (1).

More specifically, the focal length f4 of the fourth lens 40 is 4.465 mm, and the total focal length f0 of the lens system is 0.963 mm. Therefore, the ratio (f4/f0) is 4.637, satisfying the conditional expression (2).

More specifically, the total focal length f0 of the lens system is 0.963 mm, and the curvature radius R42 of the image-side lens surface of the fourth lens 40 is −4.503 mm. Therefore, the ratio (R42/f0) is −4.676, satisfying the conditional expression (3).

More specifically, the total focal length f0 of the lens system is 0.963 mm, and the center thickness T3 of the third lens 30 is 3.302 mm. Therefore, the ratio (T3/f0) is 3.429, satisfying the conditional expression (4).

More specifically, the total object-image distance do of the lens system is 15.501 mm, and the effective radius sd11 of the object-side lens surface of the first lens 10 is 5.803 mm. Therefore, the ratio (d0/sd11) is 2.671, satisfying the conditional expression (5).

More specifically, the total object-image distance d0 of the lens system is 15.501 mm, and the maximum height of image is 1.970 mm. Therefore, the ratio (d0/HOI) is 7.869, satisfying the conditional expression (6).

More specifically, the full field of angle ω of the wide-angle lens 100 is 101°. Therefore, the conditional expression (7) is satisfied.

More specifically, the total object-image distance d0 of the lens system is 15.501 mm, and the total focal length f0 of the lens system is 0.963 mm. Therefore, the ratio (d0/f0) is 16.097, satisfying the conditional expression (8).

### Embodiment 4

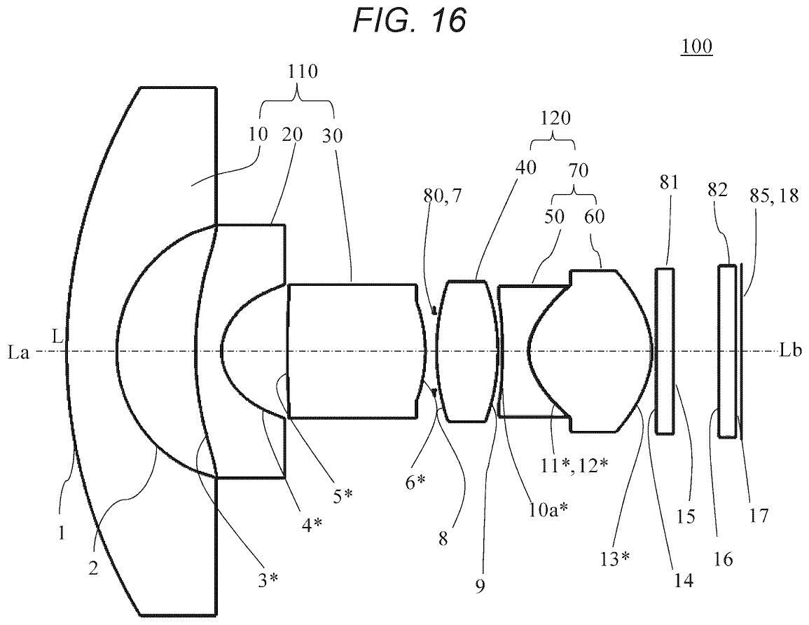

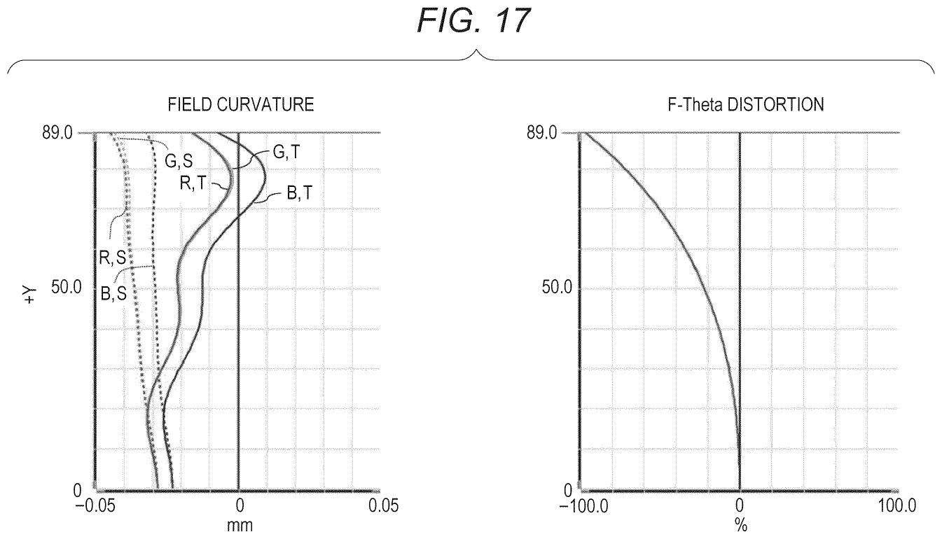

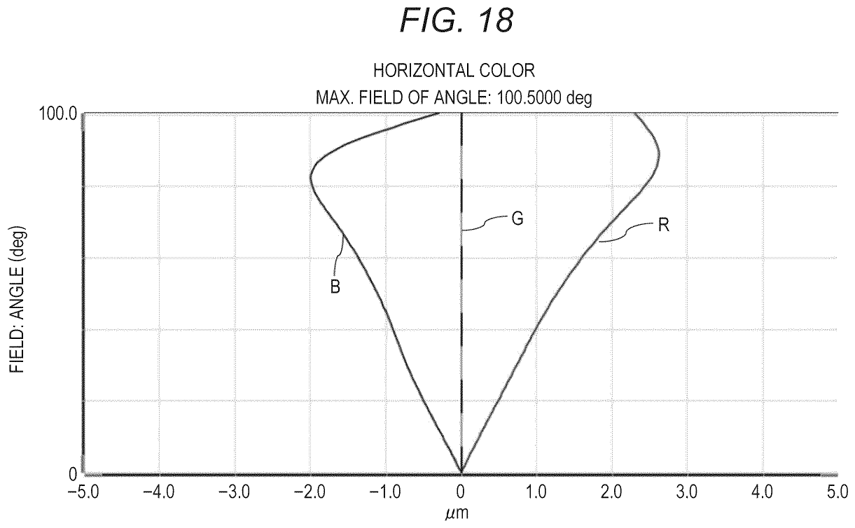

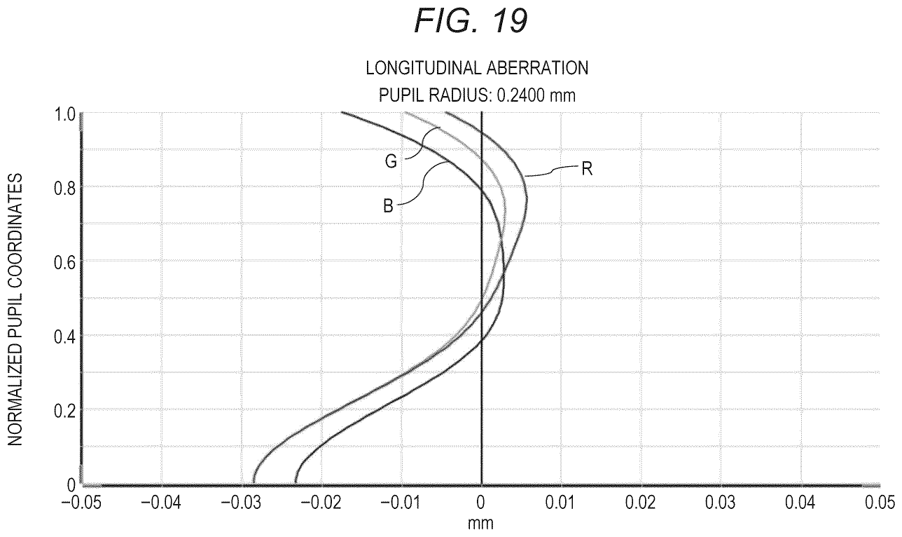

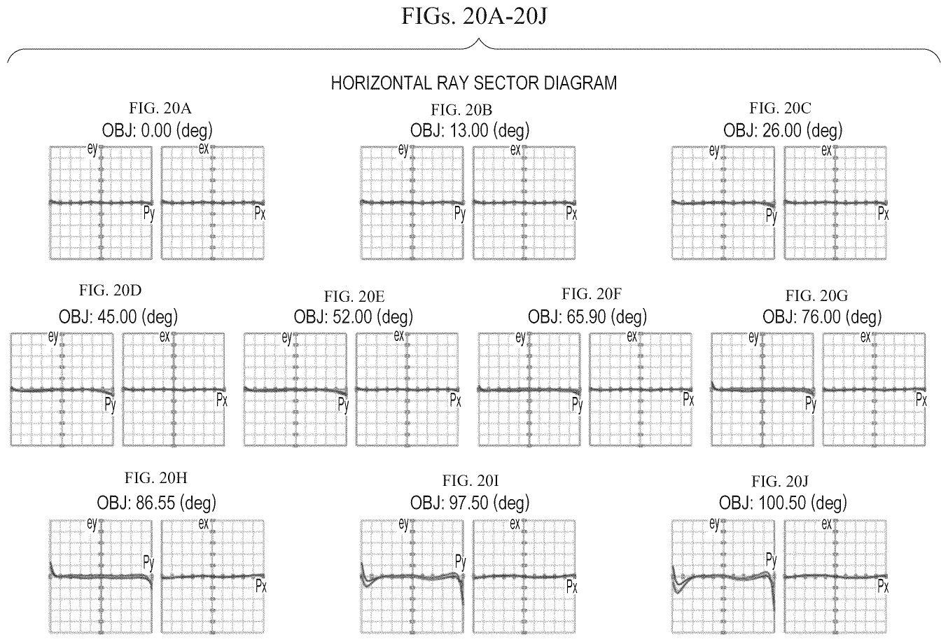

FIG. 16 is an explanatory diagram of a wide-angle lens 100 according to Embodiment 4 of the present invention. FIG. 17 is an explanatory diagram illustrating the astigmatism and distortion of the wide-angle lens 100 shown in FIG. 16. FIG. 18 is an explanatory diagram illustrating the chromatic aberration of magnification of the wide-angle lens 100 shown in FIG. 16, indicating the chromatic aberration of magnification at the maximum field angle (100.5000 deg/half angle). FIG. 19 is an explanatory diagram illustrating the spherical aberration of the wide-angle lens 100 shown in FIG. 16. FIGS. 20A to 20J are explanatory diagrams illustrating lateral aberrations of the wide-angle lens 100 shown in FIG. 16, where FIG. 20A, FIG. 20B, FIG. 20C, FIG. 20D, FIG. 20E, FIG. 20F, FIG. 20G, FIG. 20H, FIG. 20I, and FIG. 20J illustrate lateral aberrations in a tangential direction (Y direction) and a radial direction (X direction) at angles of 0.00°, 13.00°, 26.00°, 45.00°, 52.00°, 65.90°, 76.00°, 86.55°, 97.50°, and 100.50° relative to the optical axis.

As shown in FIG. 16, the wide-angle lens 100 in this embodiment, like Embodiment 1, also includes a front lens set 110, an aperture 80, and a rear lens set 120 in sequence from an object side La to an image side Lb. The front lens set 110 is composed of a first lens 10, a second lens 20, and a third lens 30 arranged in sequence from the object side La to the image side Lb. The rear lens set 120 is composed of a fourth lens 40, a fifth lens 50, and a sixth lens 60 arranged in sequence from the object side La to the image side Lb.

The structures of the lenses of the wide-angle lens 100 in this embodiment are shown in Tables 5-1 to 5-4. In the wide-angle lens 100 of this embodiment, the total focal length f0 of the lens system is 0.959 mm, the total object-image distance d0 of the lens system is 15.500 mm, the total F value of the lens system is 2.000, the maximum field of angle is 101 deg, the pupil diameter is 0.480 mm, the total length from the first lens to the sixth lens is 13.441 mm, and the maximum height of image is 1.970 mm. As shown in FIG. 17 to FIGS. 20A to 20J, in the wide-angle lens 100 of this embodiment, the astigmatism (distortion), chromatic aberration of magnification, spherical aberration, and lateral aberration are corrected to appropriate levels.

TABLE 5-1

| Effective Focal Length | 0.959 | mm |
|---|---|---|
| Total Track | 15.500 | mm |
| Image Space F/# | 2.000 | |
| Max. Field of Angle | 101 | deg |
| Pupil Diameter | 0.480 | |
| L1R1-L6R2 Track | 13.441 | mm |

| | |
|---|---|
| HOI | 1.970 |

TABLE 5-2

| Surface | Radius | Thickness | Nd | vd | f | semi-D |
|---|---|---|---|---|---|---|
| 1 | 11.650 | 1.150 | 1.804 | 46.50 | −5.292 | 6.047 |
| 2 | 2.980 | 1.808 | | | | 2.898 |
| 3* | 6.798 | 0.600 | 1.545 | 56.00 | −2.664 | 2.898 |
| 4* | 1.158 | 1.513 | | | | 1.534 |
| 5* | 20.743 | 3.167 | 1.639 | 23.03 | 4.777 | 1.534 |
| 6* | −3.366 | 0.210 | | | | 1.128 |
| 7 (aperture) | infinity | 0.050 | | | | 0.882 |
| 8 | 5.065 | 1.410 | 1.589 | 61.25 | 4.322 | 1.600 |
| 9 | −4.593 | 0.100 | | | | 1.600 |
| 10* | −25.549 | 0.600 | 1.639 | 23.03 | −1.590 | 1.222 |
| 11* | 1.068 | 0.015 | 1.486 | 56.09 | | 1.497 |
| 12* | 1.068 | 2.818 | 1.536 | 55.65 | 1.910 | 1.510 |
| 13* | −1.934 | 0.100 | | | | 1.850 |
| 14 | infinity | 0.400 | 1.517 | 64.197 | | |
| 15 | infinity | 1.034 | | | | |
| 16 | infinity | 0.400 | 1.517 | 64.197 | | |
| 17 | infinity | 0.125 | | | | |

TABLE 5-3

| Surface | c (1/Radius) | K | A4 | A6 | A8 | A10 |
|---|---|---|---|---|---|---|
| 3 | 0.147103868 | −1 | −3.52183E−03 | 5.48860E−04 | 2.49300E−04 | −8.94107E−05 |
| 4 | 0.863451866 | −1 | 1.77840E−02 | 4.16583E−02 | −3.60360E−02 | 2.57497E−02 |
| 5 | 0.048207957 | 1 | −3.02233E−03 | −8.96667E−04 | −7.91470E−04 | 7.66713E−03 |
| 6 | −0.297094152 | −1 | 7.86819E−03 | −6.29935E−02 | 1.60076E−01 | −2.43141E−01 |
| 10 | −0.039140636 | 1 | −2.93406E−02 | −1.57985E−02 | 6.34511E−02 | −1.12504E−01 |
| 11 | 0.936632353 | −1 | −4.10938E−02 | 3.10101E−02 | −5.30190E−02 | 4.65716E−02 |
| 12 | 0.936632353 | −1 | −4.10938E−02 | 3.10101E−02 | −5.30190E−02 | 4.65716E−02 |
| 13 | −0.517189789 | −1 | 1.53028E−02 | −9.65237E−03 | 4.57393E−03 | −1.23145E−03 |

TABLE 5-4

| Surface | A12 | A14 | A16 |
|---|---|---|---|
| 3 | 9.33063E−06 | −3.42575E−07 | 1.25208E−09 |
| 4 | −7.82354E−03 | 1.92874E−03 | −4.31126E−04 |
| 5 | −8.42481E−03 | 3.69094E−03 | −6.15682E−04 |
| 6 | 2.14620E−01 | −1.01597E−01 | 1.97195E−02 |
| 10 | 1.06604E−01 | −5.22427E−02 | 1.05391E−02 |
| 11 | −2.04492E−02 | 4.40142E−03 | −3.40982E−04 |
| 12 | −2.04492E−02 | 4.40142E−03 | −3.40982E−04 |
| 13 | 1.64221E−04 | −4.76255E−06 | −1.19190E−06 |

As shown in Table 2, because the wide-angle lens 100 of this embodiment satisfies the conditional expressions (1), (2), (3), (4), (5), (6), (7), and (8) described in Embodiment 1, the same effects as Embodiment 1 can be achieved.

More specifically, the total object-image distance d0 of the lens system is 15.500 mm, and the focal length f4 of the fourth lens 40 is 4.322 mm. Therefore, the ratio (d0/f4) is 3.586, satisfying the conditional expression (1).

More specifically, the focal length f4 of the fourth lens 40 is 4.322 mm, and the total focal length f0 of the lens system is 0.959 mm. Therefore, the ratio (f4/f0) is 4.507, satisfying the conditional expression (2).

More specifically, the total focal length f0 of the lens system is 0.959 mm, and the curvature radius R42 of the image-side lens surface of the fourth lens 40 is −4.593 mm. Therefore, the ratio (R42/f0) is −4.789, satisfying the conditional expression (3).

More specifically, the total focal length f0 of the lens system is 0.959 mm, and the center thickness T3 of the third lens 30 is 3.167 mm. Therefore, the ratio (T3/f0) is 3.302, satisfying the conditional expression (4).

More specifically, the total object-image distance do of the lens system is 15.500 mm, and the effective radius sd11 of the object-side lens surface of the first lens 10 is 6.047 mm. Therefore, the ratio (d0/sd11) is 2.563, satisfying the conditional expression (5).

More specifically, the total object-image distance d0 of the lens system is 15.500 mm, and the maximum height of image is 1.970 mm. Therefore, the ratio (d0/HOI) is 7.868, satisfying the conditional expression (6).

More specifically, the full field of angle ω of the wide-angle lens 100 is 101°. Therefore, the conditional expression (7) is satisfied.

More specifically, the total object-image distance d0 of the lens system is 15.500 mm, and the total focal length f0 of the lens system is 0.959 mm. Therefore, the ratio (do/f0) is 16.163, satisfying the conditional expression (8).

### Embodiment 5

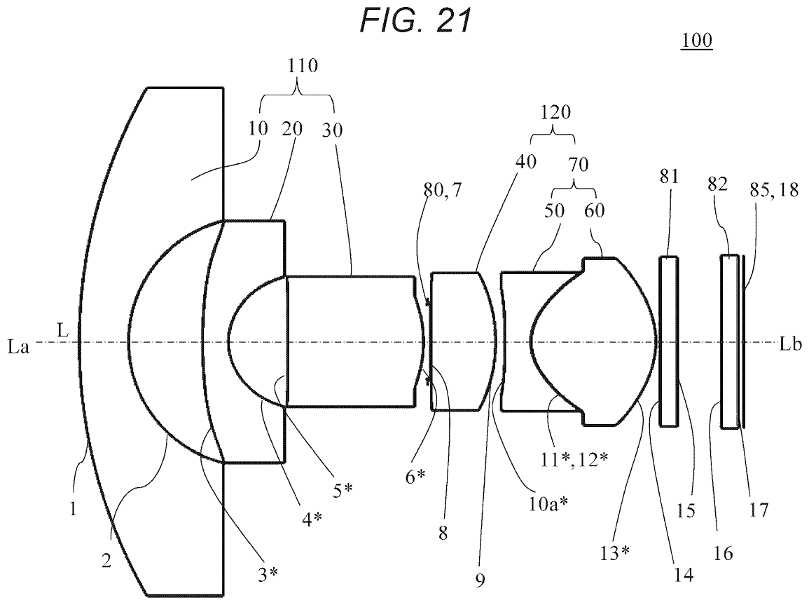

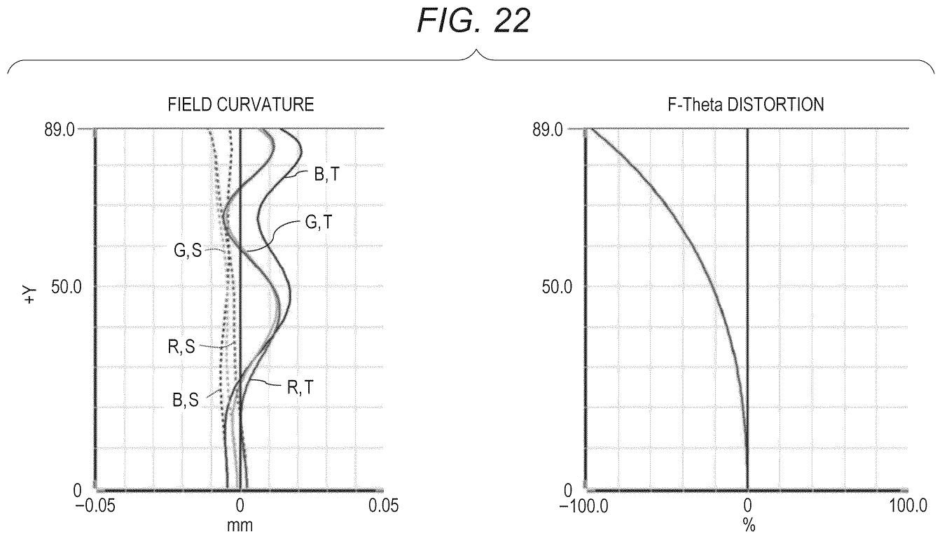

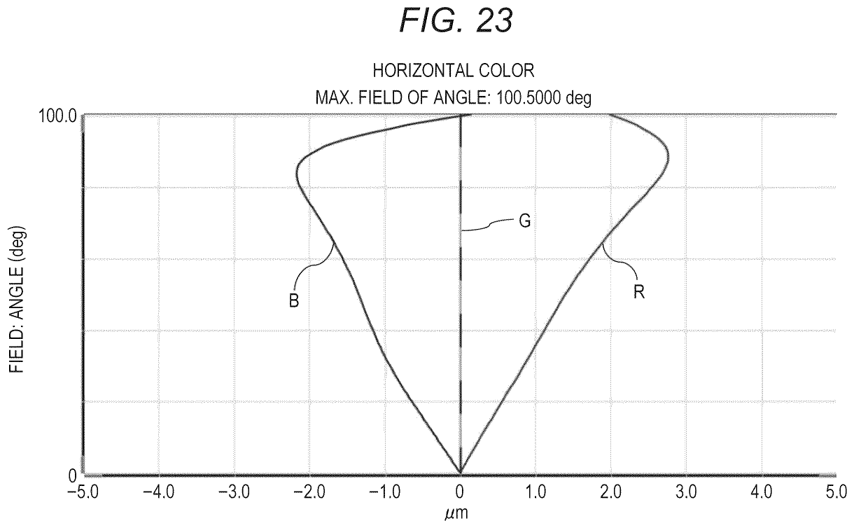

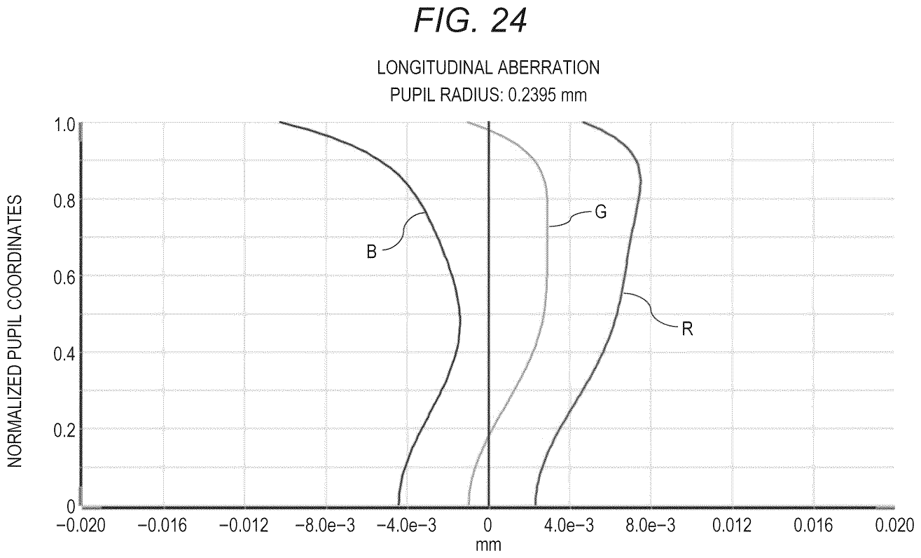

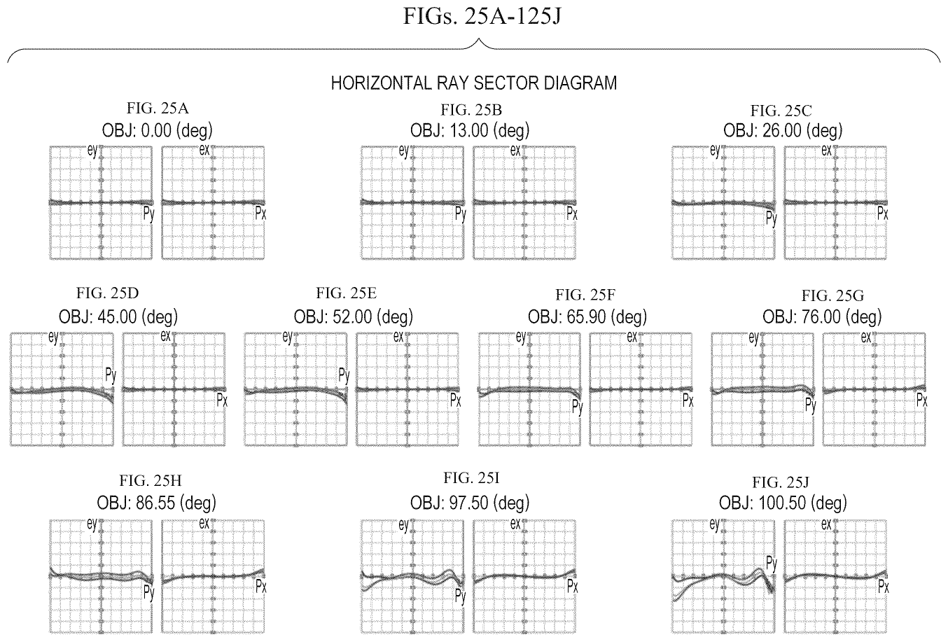

FIG. 21 is an explanatory diagram of a wide-angle lens 100 according to Embodiment 5 of the present invention. FIG. 22 is an explanatory diagram illustrating the astigmatism and distortion of the wide-angle lens 100 shown in FIG. 21. FIG. 23 is an explanatory diagram illustrating the chromatic aberration of magnification of the wide-angle lens 100 shown in FIG. 21, indicating the chromatic aberration of magnification at the maximum field angle (100.5000 deg/half angle). FIG. 24 is an explanatory diagram illustrating the spherical aberration of the wide-angle lens 100 shown in FIG. 21. FIGS. 25A to 25J are explanatory diagrams illustrating lateral aberrations of the wide-angle lens 100 shown in FIG. 21, where FIG. 25A, FIG. 25B, FIG. 25C, FIG. 25D, FIG. 25E, FIG. 25F, FIG. 25G, FIG. 25H, FIG. 25I, and FIG. 25J illustrate lateral aberrations in a tangential direction (Y direction) and a radial direction (X direction) at angles of 0.00°, 13.00°, 26.00°, 45.00°, 52.00°, 65.90°, 76.00°, 86.55°, 97.50°, and 100.50° relative to the optical axis.

As shown in FIG. 21, the wide-angle lens 100 in this embodiment, like Embodiment 1, also includes a front lens set 110, an aperture 80, and a rear lens set 120 in sequence from an object side La to an image side Lb. The front lens set 110 is composed of a first lens 10, a second lens 20, and a third lens 30 arranged in sequence from the object side La to the image side Lb. The rear lens set 120 is composed of a fourth lens 40, a fifth lens 50, and a sixth lens 60 arranged in sequence from the object side La to the image side Lb.

The structures of the lenses of the wide-angle lens 100 in this embodiment are shown in Tables 6-1 to 6-4. In the wide-angle lens 100 of this embodiment, the total focal length f0 of the lens system is 0.957 mm, the total object-image distance do of the lens system is 15.499 mm, the total F value of the lens system is 2.000, the maximum field of angle is 101 deg, the pupil diameter is 0.479 mm, the total length from the first lens to the sixth lens is 13.449 mm, and the maximum height of image is 1.970 mm. As shown in FIG. 22 to FIGS. 25A to 25J, in the wide-angle lens 100 of this embodiment, the astigmatism (distortion), chromatic aberration of magnification, spherical aberration, and lateral aberration are corrected to appropriate levels.

TABLE 6-1

| Effective Focal Length | 0.957 | mm |
|---|---|---|
| Total Track | 15.499 | mm |
| Image Space F/# | 2.000 | |
| Max. Field of Angle | 101 | deg |
| Pupil Diameter | 0.479 | |
| L1R1-L6R2 Track | 13.449 | mm |

| | |
|---|---|
| HOI | 1.970 |

TABLE 6-2

| Surface | Radius | Thickness | Nd | vd | f | semi-D |
|---|---|---|---|---|---|---|
| 1 | 11.821 | 1.150 | 1.804 | 46.50 | −5.053 | 5.903 |
| 2 | 2.893 | 1.728 | | | | 2.811 |
| 3* | 11.240 | 0.600 | 1.536 | 55.65 | −2.786 | 2.811 |
| 4* | 1.293 | 1.383 | | | | 1.514 |
| 5* | 40.885 | 3.168 | 1.639 | 23.03 | 4.063 | 1.514 |
| 6* | −2.688 | 0.100 | | | | 1.070 |
| 7 (aperture) | infinity | 0.066 | | | | 0.867 |
| 8 | 51.466 | 1.516 | 1.697 | 55.46 | 4.653 | 1.600 |
| 9 | −3.418 | 0.217 | | | | 1.600 |
| 10* | −15.212 | 0.600 | 1.639 | 23.03 | −1.600 | 1.285 |
| 11* | 1.113 | 0.015 | 1.486 | 56.09 | | 1.607 |
| 12* | 1.113 | 2.905 | 1.536 | 55.65 | 1.975 | 1.639 |
| 13* | −1.917 | 0.100 | | | | 1.942 |
| 14 | infinity | 0.400 | 1.517 | 64.197 | | |
| 15 | infinity | 1.025 | | | | |
| 16 | infinity | 0.400 | 1.517 | 64.197 | | |
| 17 | infinity | 0.125 | | | | |

TABLE 6-3

| Surface | c (1/Radius) | K | A4 | A6 | A8 | A10 |
|---|---|---|---|---|---|---|
| 3 | 0.088970711 | −1 | 4.98964E−04 | 1.01939E−03 | −5.85761E−05 | −7.71510E−06 |
| 4 | 0.773693627 | −1 | 6.36539E−03 | 2.95353E−02 | −1.34498E−02 | 6.21388E−03 |
| 5 | 0.024458763 | 1 | −1.64114E−02 | 6.54323E−03 | −2.36205E−03 | 4.16263E−04 |
| 6 | −0.371977241 | −1 | 5.27523E−03 | −7.54391E−03 | 1.06356E−02 | −7.37414E−03 |
| 10 | −0.065738583 | 1 | −6.93855E−03 | −1.32782E−02 | 1.69698E−02 | −2.10282E−02 |
| 11 | 0.898572074 | −1 | 3.80469E−02 | −4.45989E−02 | 9.24593E−03 | 3.12532E−03 |
| 12 | 0.898572074 | −1 | 3.80469E−02 | −4.45989E−02 | 9.24593E−03 | 3.12532E−03 |
| 13 | −0.521548493 | −1 | 1.56684E−02 | −5.51019E−03 | 3.71262E−04 | 5.67842E−04 |

TABLE 6-4

| Surface | A12 | A14 | A16 |
|---|---|---|---|
| 3 | 2.54627E−07 | 5.06118E−08 | −5.53211E−09 |
| 4 | 1.78623E−04 | 7.35274E−05 | −4.40740E−05 |
| 5 | −2.98008E−05 | 2.04213E−05 | −5.38876E−06 |
| 6 | −1.11618E−04 | 2.43078E−03 | −8.80408E−04 |
| 10 | 1.41958E−02 | −3.35206E−03 | −6.03991E−05 |
| 11 | −1.09185E−04 | −2.98682E−04 | 6.08596E−06 |
| 12 | −1.09185E−04 | −2.98682E−04 | 6.08596E−06 |
| 13 | −1.91178E−04 | 1.64080E−05 | −5.14643E−07 |

As shown in Table 2, because the wide-angle lens 100 of this embodiment satisfies the conditional expressions (1), (2), (3), (4), (5), (6), (7), and (8) described in Embodiment 1, the same effects as Embodiment 1 can be achieved.

More specifically, the total object-image distance d0 of the lens system is 15.499 mm, and the focal length f4 of the fourth lens 40 is 4.653 mm. Therefore, the ratio (d0/f4) is 3.331, satisfying the conditional expression (1).

More specifically, the focal length f4 of the fourth lens 40 is 4.653 mm, and the total focal length f0 of the lens system is 0.957 mm. Therefore, the ratio (f4/f0) is 4.862, satisfying the conditional expression (2).

More specifically, the total focal length f0 of the lens system is 0.957 mm, and the curvature radius R42 of the image-side lens surface of the fourth lens 40 is −3.418 mm. Therefore, the ratio (R42/f0) is −3.572, satisfying the conditional expression (3).

More specifically, the total focal length f0 of the lens system is 0.957 mm, and the center thickness T3 of the third lens 30 is 3.168 mm. Therefore, the ratio (T3/f0) is 3.310, satisfying the conditional expression (4).

More specifically, the total object-image distance do of the lens system is 15.499 mm, and the effective radius sd11 of the object-side lens surface of the first lens 10 is 5.903 mm. Therefore, the ratio (d0/sd11) is 2.626, satisfying the conditional expression (5).

More specifically, the total object-image distance d0 of the lens system is 15.499 mm, and the maximum height of image is 1.970 mm. Therefore, the ratio (d0/HOI) is 7.868, satisfying the conditional expression (6).

More specifically, the full field of angle ω of the wide-angle lens 100 is 101°. Therefore, the conditional expression (7) is satisfied.

More specifically, the total object-image distance do of the lens system is 15.499 mm, and the total focal length f0 of the lens system is 0.957 mm. Therefore, the ratio (do/f0) is 16.195, satisfying the conditional expression (8).

### Embodiment 6

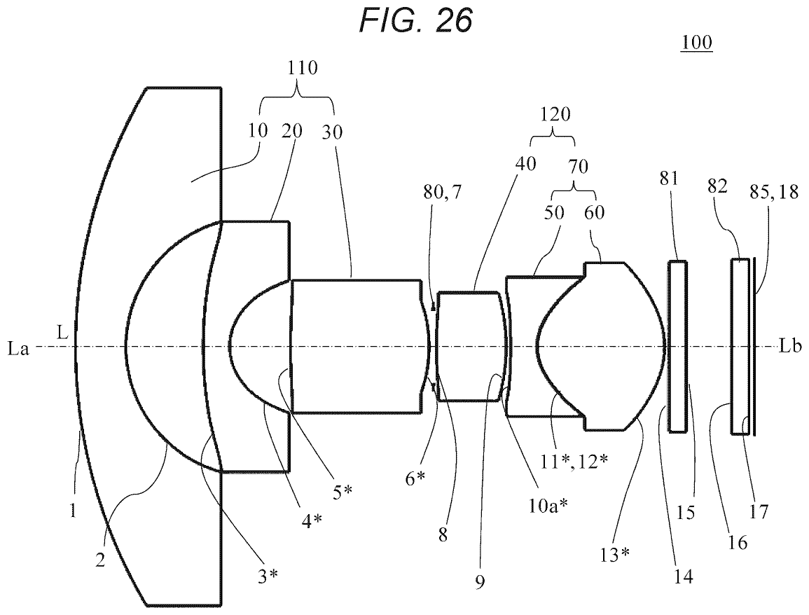

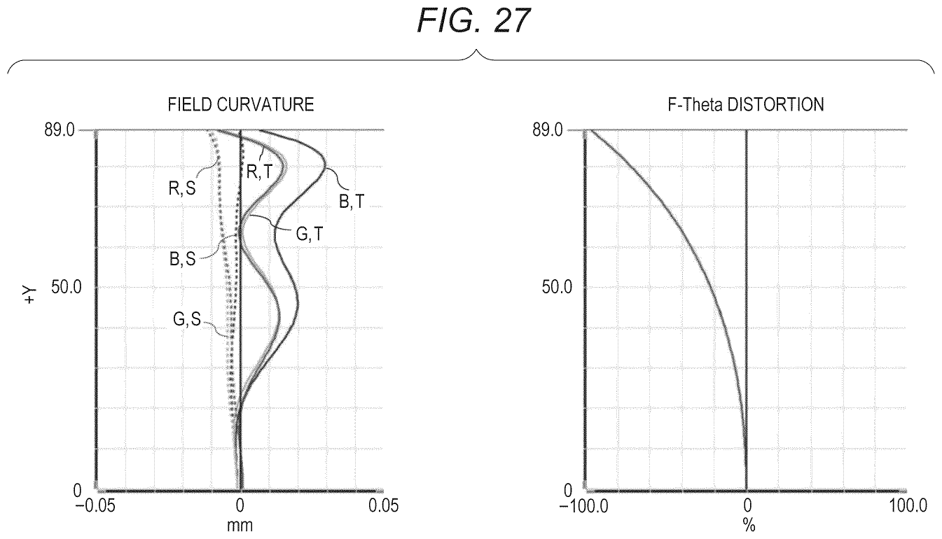

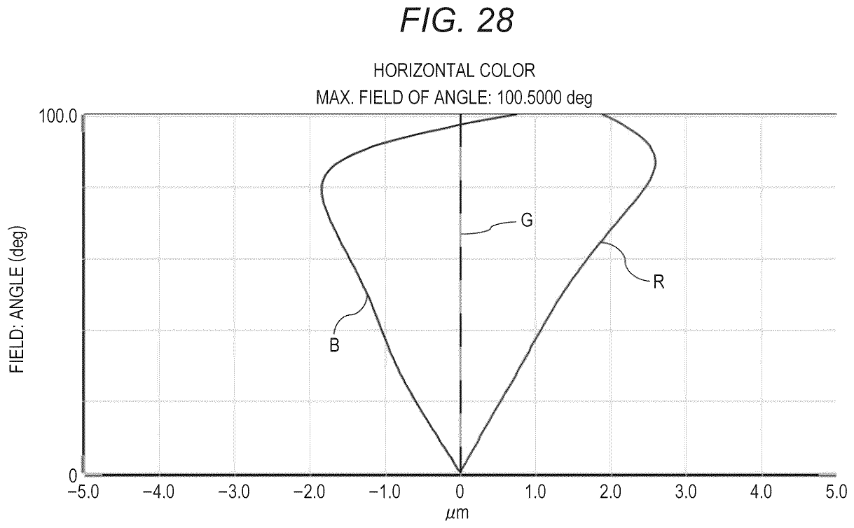

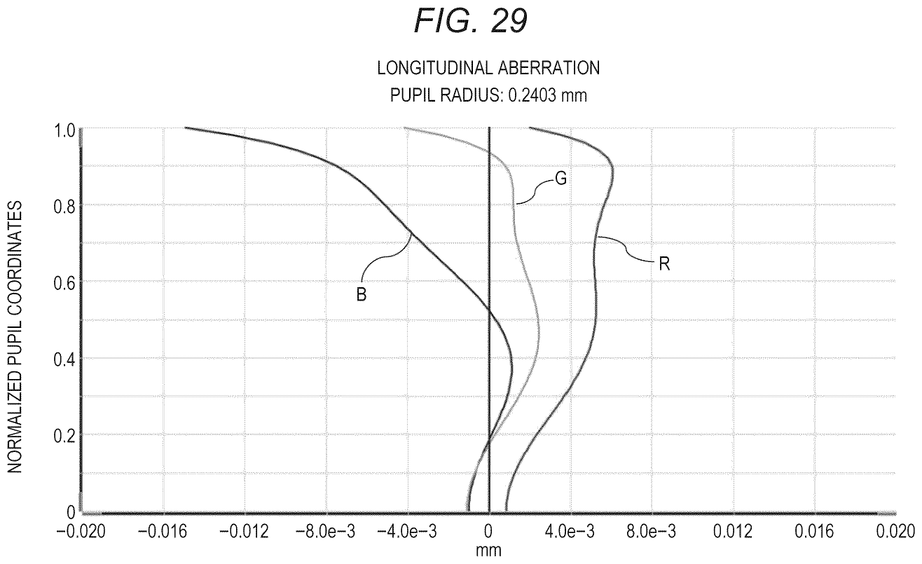

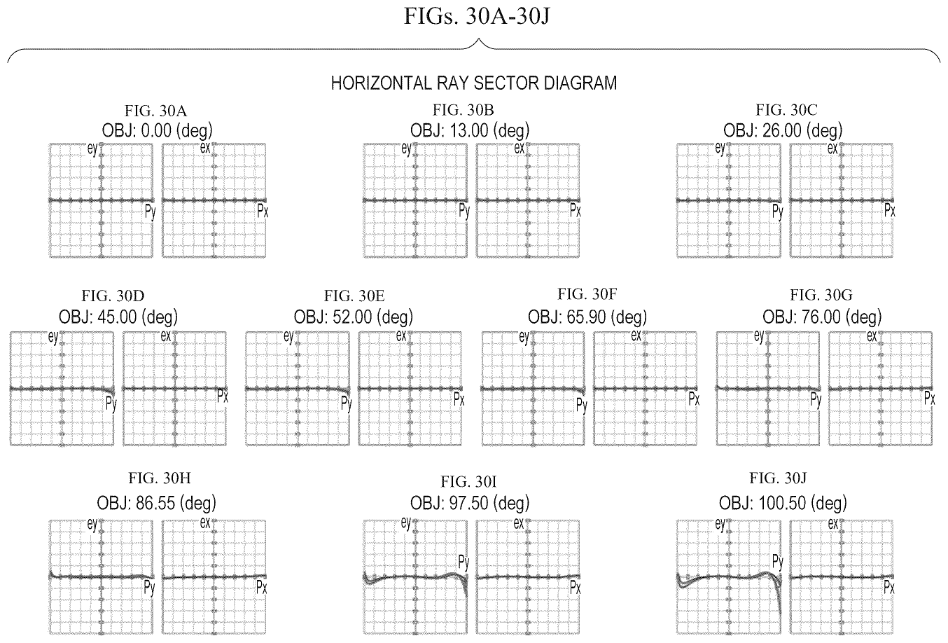

FIG. 26 is an explanatory diagram of a wide-angle lens 100 according to Embodiment 6 of the present invention. FIG. 27 is an explanatory diagram illustrating the astigmatism and distortion of the wide-angle lens 100 shown in FIG. 26. FIG. 28 is an explanatory diagram illustrating the chromatic aberration of magnification of the wide-angle lens 100 shown in FIG. 26, indicating the chromatic aberration of magnification at the maximum field angle (100.5000 deg/half angle). FIG. 29 is an explanatory diagram illustrating the spherical aberration of the wide-angle lens 100 shown in FIG. 26. FIGS. 30A to 30J are explanatory diagrams illustrating lateral aberrations of the wide-angle lens 100 shown in FIG. 26, where FIG. 30A, FIG. 30B, FIG. 30C, FIG. 30D, FIG. 30E, FIG. 30F, FIG. 20G, FIG. 30H, FIG. 30I, and FIG. 30J illustrate lateral aberrations in a tangential direction (Y direction) and a radial direction (X direction) at angles of 0.00°, 13.00°, 26.00°, 45.00°, 52.00°, 65.90°, 76.00°, 86.55°, 97.50°, and 100.50° relative to the optical axis.

As shown in FIG. 26, the wide-angle lens 100 in this embodiment, like Embodiment 1, also includes a front lens set 110, an aperture 80, and a rear lens set 120 in sequence from an object side La to an image side Lb. The front lens set 110 is composed of a first lens 10, a second lens 20, and a third lens 30 arranged in sequence from the object side La to the image side Lb. The rear lens set 120 is composed of a fourth lens 40, a fifth lens 50, and a sixth lens 60 arranged in sequence from the object side La to the image side Lb.

The structures of the lenses of the wide-angle lens 100 in this embodiment are shown in Tables 7-1 to 7-4. In the wide-angle lens 100 of this embodiment, the total focal length f0 of the lens system is 0.960 mm, the total object-image distance do of the lens system is 15.497 mm, the total F value of the lens system is 2.000, the maximum field of angle is 101 deg, the pupil diameter is 0.480 mm, the total length from the first lens to the sixth lens is 13.444 mm, and the maximum height of image is 1.970 mm. As shown in FIG. 27 to FIGS. 30A to 30J, in the wide-angle lens 100 of this embodiment, the astigmatism (distortion), chromatic aberration of magnification, spherical aberration, and lateral aberration are corrected to appropriate levels.

TABLE 7-1

| Effective Focal Length | 0.960 | mm |
|---|---|---|
| Total Track | 15.497 | mm |
| Image Space F/# | 2.000 | |
| Max. Field of Angle | 101 | deg |
| Pupil Diameter | 0.480 | |
| L1R1-L6R2 Track | 13.444 | mm |

| | |
|---|---|
| HOI | 1.970 |

TABLE 7-2

| Surface | Radius | Thickness | Nd | vd | f | semi-D |
|---|---|---|---|---|---|---|
| 1 | 11.520 | 1.150 | 1.804 | 46.50 | −5.252 | 5.897 |
| 2 | 2.953 | 1.767 | | | | 2.848 |
| 3* | 9.937 | 0.600 | 1.545 | 56.00 | −2.607 | 2.848 |
| 4* | 1.216 | 1.392 | | | | 1.510 |
| 5* | 15.538 | 3.160 | 1.639 | 23.03 | 4.319 | 1.510 |
| 6* | −3.090 | 0.100 | | | | 1.045 |
| 7 (aperture) | infinity | 0.066 | | | | 0.860 |
| 8 | 10.023 | 1.591 | 1.697 | 55.46 | 4.569 | 0.924 |
| 9 | −4.362 | 0.100 | | | | 1.226 |
| 10* | −22.938 | 0.600 | 1.639 | 23.03 | −1.615 | 1.257 |
| 11* | 1.091 | 0.015 | 1.486 | 56.09 | | 1.589 |
| 12* | 1.091 | 2.902 | 1.536 | 55.65 | 1.955 | 1.600 |
| 13* | −1.869 | 0.100 | | | | 1.908 |
| 14 | infinity | 0.400 | 1.517 | 64.197 | | |
| 15 | infinity | 1.028 | | | | |
| 16 | infinity | 0.400 | 1.517 | 64.197 | | |
| 17 | infinity | 0.125 | | | | |

TABLE 7-3

| Surface | c (1/Radius) | K | A4 | A6 | A8 | A10 |
|---|---|---|---|---|---|---|
| 3 | 0.100638125 | −1 | −3.00063E−04 | 9.02983E−04 | −8.20373E−05 | −9.41309E−06 |
| 4 | 0.822548466 | −1 | 2.12021E−02 | 3.15097E−02 | −1.58596E−02 | 6.94199E−03 |
| 5 | 0.064358809 | 1 | −7.58135E−03 | 4.12549E−03 | −1.80990E−03 | 5.32136E−04 |
| 6 | −0.32361472 | −1 | −1.49244E−03 | −9.61385E−03 | 1.37236E−02 | −7.90571E−03 |
| 10 | −0.043596123 | 1 | −1.88290E−02 | −1.14825E−02 | 1.65370E−02 | −2.07254E−02 |
| 11 | 0.916310204 | −1 | 1.46956E−02 | −4.37308E−02 | 1.23695E−02 | 3.24792E−03 |
| 12 | 0.916310204 | −1 | 1.46956E−02 | −4.37308E−02 | 1.23695E−02 | 3.24792E−03 |
| 13 | −0.535090041 | −1 | 1.30407E−02 | −4.87002E−03 | 4.75261E−04 | 5.20508E−04 |

TABLE 7-4

| Surface | A12 | A14 | A16 |
|---|---|---|---|
| 3 | 4.74607E−07 | 9.18352E−08 | −5.94927E−09 |
| 4 | 9.45923E−04 | 1.10031E−04 | −3.18499E−04 |
| 5 | −7.07465E−05 | 2.80858E−05 | −4.03796E−05 |
| 6 | −2.43485E−03 | 5.34113E−03 | −2.51038E−03 |
| 10 | 1.48680E−02 | −3.57838E−03 | −1.64979E−04 |
| 11 | −4.67684E−04 | −2.90409E−04 | −2.05812E−06 |
| 12 | −4.67684E−04 | −2.90409E−04 | −2.05812E−06 |
| 13 | −2.00569E−04 | 2.05009E−05 | −4.98635E−07 |

As shown in Table 2, because the wide-angle lens 100 of this embodiment satisfies the conditional expressions (1), (2), (3), (4), (5), (6), (7), and (8) described in Embodiment 1, the same effects as Embodiment 1 can be achieved.

More specifically, the total object-image distance d0 of the lens system is 15.497 mm, and the focal length f4 of the fourth lens 40 is 4.569 mm. Therefore, the ratio (d0/f4) is 3.392, satisfying the conditional expression (1).

More specifically, the focal length f4 of the fourth lens 40 is 4.569 mm, and the total focal length f0 of the lens system is 0.960 mm. Therefore, the ratio (f4/f0) is 4.759, satisfying the conditional expression (2).

More specifically, the total focal length f0 of the lens system is 0.960 mm, and the curvature radius R42 of the image-side lens surface of the fourth lens 40 is −4.362 mm. Therefore, the ratio (R42/f0) is −4.544, satisfying the conditional expression (3).

More specifically, the total focal length f0 of the lens system is 0.960 mm, and the center thickness T3 of the third lens 30 is 3.160 mm. Therefore, the ratio (T3/f0) is 3.292, satisfying the conditional expression (4).

More specifically, the total object-image distance d0 of the lens system is 15.497 mm, and the effective radius sd11 of the object-side lens surface of the first lens 10 is 5.897 mm. Therefore, the ratio (d0/sd11) is 2.628, satisfying the conditional expression (5).

More specifically, the total object-image distance d0 of the lens system is 15.497 mm, and the maximum height of image is 1.970 mm. Therefore, the ratio (d0/HOI) is 7.866, satisfying the conditional expression (6).

More specifically, the full field of angle ω of the wide-angle lens 100 is 101°. Therefore, the conditional expression (7) is satisfied.

More specifically, the total object-image distance d0 of the lens system is 15.497 mm, and the total focal length f0 of the lens system is 0.960 mm. Therefore, the ratio (d0/f0) is 16.143, satisfying the conditional expression (8).

### OTHER EMBODIMENTS

The first lens 10 is a glass lens in the above embodiments, but it may alternatively be a plastic lens. In this case, the image-side Lb lens surface of the first lens 10 may be an aspheric surface.

What is claimed is:

1. A wide-angle lens comprising:
a front lens set, an aperture, and a rear lens set in sequence from an object side to an image side, wherein
the front lens set is composed of a first lens, a second lens, and a third lens arranged in sequence from the object side to the image side,
the rear lens set is composed of a fourth lens, a fifth lens, and a sixth lens arranged in sequence from the object side to the image side,
the first lens is a negative lens with a concave lens surface facing the image side,
the second lens is a negative lens with a concave lens surface facing the image side,
the third lens is a positive lens with a convex lens surface facing the image side,
the fourth lens is a glass biconvex lens,
the fifth lens is a lens with a concave lens surface facing the image side,
the sixth lens is a biconvex lens, and
when the total object-image distance of the lens system is denoted as do, and the focal length of the fourth lens is denoted as f4, the following conditional expression is satisfied:
$$3. < d 0 / f 4 < 4.000 .$$

2. The wide-angle lens according to claim 1, wherein
$$3. 331 < d 0 / f 4 < 3.58 6 .$$

3. The wide-angle lens according to claim 1, wherein
when the total focal length of the lens system is denoted as f0, the following conditional expression is satisfied:
$$3.5 < f 4 / f 0 < 5.5 0 .$$

4. The wide-angle lens according to claim 3, wherein
$$4. 000 < f 4 / f 0 < 5. 0 .$$

5. The wide-angle lens according to claim 1, wherein
when the total focal length of the lens system is denoted as f0 and the curvature radius of the image-side lens surface of the fourth lens is denoted as R42, the following conditional expression is satisfied:
$$- 7.500 < R 42 / f 0 < - 3.5 \; 0 .$$

6. The wide-angle lens according to claim 1, wherein
when the total focal length of the lens system is denoted as f0 and the center thickness of the third lens is denoted as T3, the following conditional expression is satisfied:
$$2. 000 < T 3 / f 0 < 4.000 .$$

7. The wide-angle lens according to claim 1, wherein
when the effective radius of the object-side lens surface of the first lens is denoted as sd11, the following conditional expression is satisfied:
$$2. 000 < d 0 / sd 11 < 3. .$$

8. The wide-angle lens according to claim 1, wherein
when the maximum height of image is denoted as HOI, the following conditional expression is satisfied:
$$5. 000 < d 0 / HOI < 10.000 .$$

9. The wide-angle lens according to claim 1, wherein
when the full field of angle of the wide-angle lens is denoted as ω, the following conditional expression is satisfied:
$$180 ° < ω < 210 ° .$$

10. The wide-angle lens according to claim 1, wherein
when the total focal length of the lens system is denoted as f0, the following conditional expression is satisfied:
$$13. < d 0 / f 0 < 18. 0 .$$
